(19) United States
(12) Patent Application Publication
(10) Pub. No.: US 2020/0037106 A1
(43) Pub. Date: Jan. 30, 2020

(54) SERVICE ACTIVITY SUPPORT METHOD AND SERVICE ACTIVITY SUPPORT SYSTEM

(71) Applicant: FUJITSU LIMITED, Kawasaki-shi (JP)

(72) Inventors: SHINICHI SHIOTSU, Kawasaki (JP); Akira FUJII, Machida (JP); Akira Karasudani, Yamato (JP); Miho Murata, Kawasaki (JP); MINORU SEKIGUCHI, Chuou (JP)

(73) Assignee: FUJITSU LIMITED, Kawasaki-shi (JP)

(21) Appl. No.: 16/516,279

(22) Filed: Jul. 19, 2019

(30) Foreign Application Priority Data
Jul. 24, 2018 (JP) 2018-138560

(51) Int. Cl. H04W 4/024; H04W 4/14; H04W 4/021; H04W 4/029

(52) U.S. Cl. CPC H04W 4/024; H04W 4/029; H04W 4/021; H04W 4/14

(57) ABSTRACT

A service activity support method includes, in response to receiving a request for support of a first service activity transmitted from a first terminal device positioned in a specific area determined virtually in a map, identifying a second terminal device positioned in the specific area, the second terminal device being different from the first terminal device, and transmitting information regarding the request to the identified second terminal device.

### CROSS-REFERENCE TO RELATED APPLICATION

This application is based upon and claims the benefit of priority of the prior Japanese Patent Application No. 2018-138560, filed on Jul. 24, 2018, the entire contents of which are incorporated herein by reference.

### FIELD

The embodiments discussed herein are related to a service activity support technique.

### BACKGROUND

A technique called geo-fencing in which, when it is detected that a mobile terminal has entered a specific area defined by a virtual fence (geo fence), a user holding the terminal is notified of an entry into the area or the entry into the area is transmitted to the outside is known.

For example, related techniques are disclosed in Japanese National Publication of International Patent Application No. 2011-524123, Japanese Laid-open Patent Publication No. 2017-111001, and Japanese National Publication of International Patent Application No. 2015-524950.

### SUMMARY

According to an aspect of the embodiments, a service activity support method includes, in response to receiving a request for support of a first service activity transmitted from a first terminal device positioned in a specific area determined virtually in a map, identifying a second terminal device positioned in the specific area, the second terminal device being different from the first terminal device, and transmitting information regarding the request to the identified second terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a service activity support system according to Embodiment 1;

FIG. 2A illustrates a screen display example of a first user terminal according to Embodiment 1 and FIGS. 2B and 2C illustrate screen display examples of a second user terminal according to Embodiment 1;

FIG. 3 illustrates an example of a hardware configuration of the first user terminal;

FIG. 4 illustrates an example of a hardware configuration of a management server;

FIG. 5 illustrates an example of a block diagram of the first user terminal according to Embodiment 1;

FIG. 6 illustrates an example of a local area management table according to Embodiment 1;

FIG. 7 illustrates an example of a block diagram of a management server according to Embodiment 1;

FIG. 8A illustrates an example of a static area management table according to Embodiment 1, FIG. 8B illustrates an example of an area service management table according to Embodiment 1, FIG. 8C illustrates an example of an application data management table according to Embodiment 1, and FIG. 8D illustrates an example of a terminal state management table according to Embodiment 1;

FIG. 9 is a flowchart illustrating an example of an operation of the first user terminal according to Embodiment 1;

FIG. 10 is a flowchart illustrating an example of an operation of the management server according to Embodiment 1;

FIG. 11 is a flowchart illustrating an example an operation of a service application unit;

FIG. 12 illustrates an example of a service activity support system according to Embodiment 2;

FIGS. 13A, 13B, 13C, and 13D illustrate screen display examples of a second user terminal according to Embodiment 2;

FIGS. 14A, 14B, and 14C illustrate screen display examples of a first user terminal according to Embodiment 2;

FIG. 15 illustrates an example of a block diagram of the first user terminal according to Embodiment 2;

FIG. 16 illustrates an example of the local area management table;

FIG. 17 illustrates an example of a block diagram of a management server according to Embodiment 2;

FIG. 18A illustrates an example of a static area management table according to Embodiment 2, FIG. 18B illustrates an example of an area service management table according to Embodiment 2, FIG. 18C illustrates an example of an application data management table according to Embodiment 2, and FIG. 18D illustrates an example of a terminal state management table according to Embodiment 2;

FIG. 19 is a flowchart illustrating an example of an operation of the first user terminal according to Embodiment 2;

FIG. 20 is a flowchart illustrating an example of an operation of the management server according to Embodiment 2;

FIG. 21 is a flowchart illustrating an example of the operation of the service application unit according to Embodiment 2;

FIG. 22A is a flowchart illustrating a part of operations of a first user terminal according to Embodiment 3 and FIGS. 22B and 22C illustrate examples of screens respectively displayed on the first user terminal and a second user terminal according to Embodiment 3;

FIGS. 23A, 23B, 23C, and 23D illustrate other examples of screens displayed on the first user terminal and the second user terminal according to Embodiment 3, respectively;

FIG. 24 illustrates an example of a terminal state management table according to Embodiment 4;

FIGS. 25A and 25B illustrate screen display examples of a second user terminal according to Embodiment 4 and FIGS. 25C and 25D illustrate screen display examples of a first user terminal according to Embodiment 4;

FIG. 26 illustrates an example of a terminal state management table according to Embodiment 5;

FIGS. 27A, 27B, 27C, and 27D illustrate screen display examples of a first user terminal according to Embodiment 5;

FIG. 28 illustrates an example of a service activity support system according to Embodiment 6;

FIGS. 29A and 29B illustrate screen display examples of a first user terminal according to Embodiment 6;

FIG. 30 illustrates an example of a block diagram of the first user terminal according to Embodiment 6;

FIG. 31 illustrates an example of a local area management table according to Embodiment 6;

FIG. 32 illustrates an example of a block diagram of a management server according to Embodiment 6;

FIG. 33A illustrates an example of a terminal state management table according to Embodiment 6, FIG. 33B illustrates an example of a setting range management table according to Embodiment 6, and FIG. 33C illustrates an example of a dynamic area management table according to Embodiment 6;

FIG. 34A is a flowchart illustrating a part of operations of the first user terminal according to Embodiment 6 and FIG. 34B is a flowchart illustrating an example of a candidate search process; and

FIG. 35 is a flowchart exemplifying a part of operations of the management server according to Embodiment 6.

### DESCRIPTION OF EMBODIMENTS

In this specification, volunteering is defined as service activity that contributes to people and society on a paid or free basis based on voluntary will, a person who performs volunteering is defined as a supporter and a person who requests volunteering as a requester. Hereinafter, a plurality of embodiments for a service activity support method, a service activity support program, and a service activity support system, which is an example of a system, that support the service activity will be described.

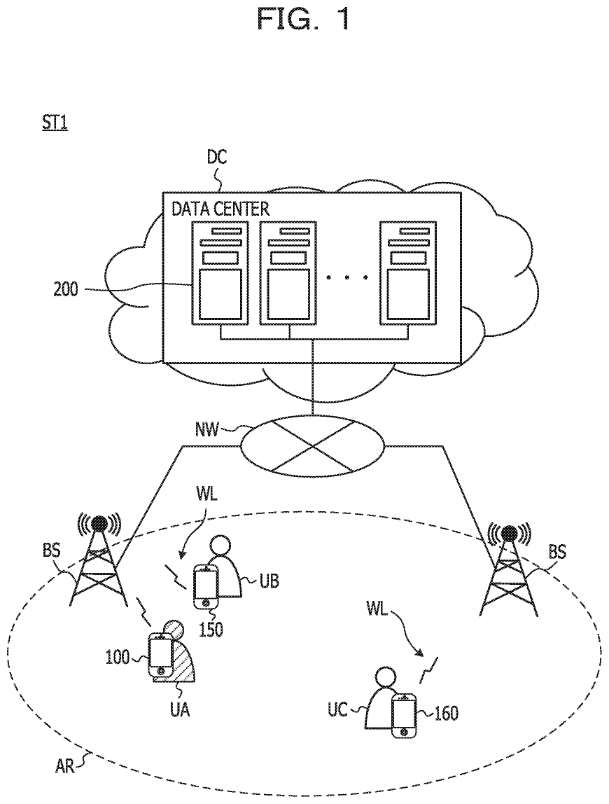

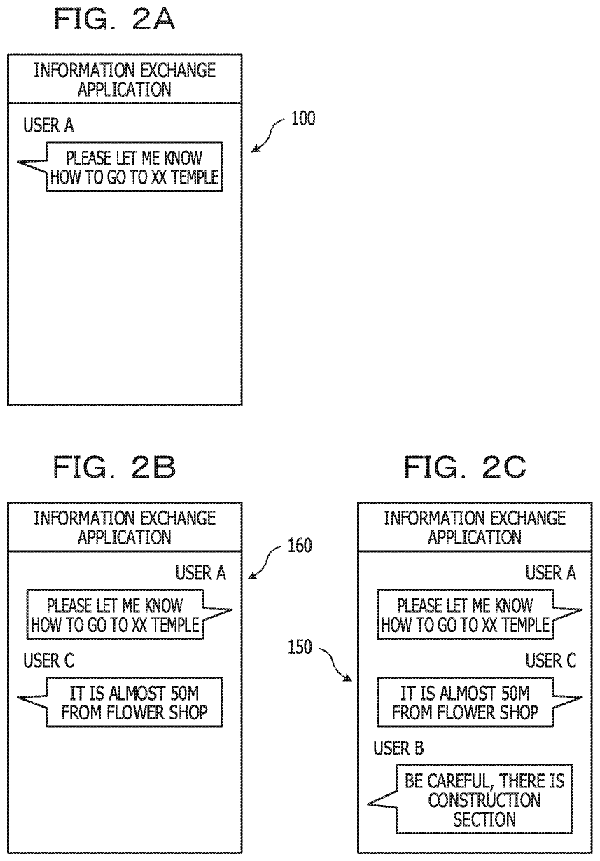

FIG. 1 illustrates an example of a service activity support system ST1 according to Embodiment 1. FIG. 2A illustrates a screen display example of a first user terminal 100 according to Embodiment 1. FIGS. 2B and 2C illustrate screen display examples of second user terminals 150 and 160 according to Embodiment 1. The service activity support system ST1 includes a management server 200. The components of the service activity support system ST1 may include a plurality of user terminals including one first user terminal 100 and two second user terminals 150 and 160. In FIG. 1, a smartphone is illustrated as an example of the first user terminal 100 and the second user terminals 150 and 160, but a terminal device such as a tablet terminal or a wearable device may be used. On the other hand, the management server 200 is installed in a data center DC or the like that provides various cloud services. The management server 200 may not be installed in the data center DC, but may be installed in an office or the like of a company or a group that aims to popularize tourism resources. For example, the management server 200 may be a so-called on-premise type server.

As long as the first user terminal 100, the second user terminals 150 and 160, and the management server 200 are included in a communicable area of a portable base station BS, the first user terminal 100, the second user terminals 150 and 160, and the management server 200 are connected to each other through a wireless communication WL and a communication network NW. Long Term Evolution (LTE) or the like is used as the wireless communication WL and the Internet is used as the communication network NW, for example. Thus, the first user terminal 100 and the second user terminals 150 and 160 may connect to the management server 200 using the wireless communication WL and the communication network NW. Accordingly, the first user terminal 100 and the second user terminals 150 and 160 may be connected to each other through the management server 200.

As illustrated in FIG. 1, the first user terminal 100 is carried by a user UA. On the other hand, the second user terminal 150 is carried by a user UB, and the second user terminal 160 is carried by a user UC. In the first user terminal 100 and the second user terminals 150 and 160, application software (hereinafter, simply referred to as an application) capable of transmitting and receiving information (hereinafter, simply referred to as a message) including a message to each other is installed. When current positions of the first user terminal 100 and the second user terminals 150, 160 are both included in the same service area AR, the management server 200 according to Embodiment 1 makes it possible to group the first user terminal 100 and the second user terminals 150 and 160 and to transmit and receive the message to each other. Accordingly, for example, by sending a message indicating that a certain user has troubled, another user existing in the same service area AR may offer support. The other user may realize volunteering support service such as sending information useful for a certain user as a message.

For example, as illustrated in FIG. 2A, when the user UA inputs a message for requesting support for route guidance to the first user terminal 100, the first user terminal 100 transmits the input message. The management server 200 receives the message transmitted from the first user terminal 100, and the management server 200 transmits the received message to the second user terminals 150 and 160 existing in the same service area AR. When the second user terminals 150 and 160 receive the message, the second user terminals 150 and 160 respectively display the received message.

For example, when the user UC confirms the message, as illustrated in FIG. 2B, the user UC inputs a message supporting the route guidance to the second user terminal 160. When the user UB confirms the message after the user UC, as illustrated in FIG. 2C, the user UB inputs a message to draw attention to the action of the user UA to the second user terminal 150. The second user terminals 150 and 160 respectively transmit the input message. The management server 200 receives the messages respectively transmitted from the second user terminals 150 and 160, and the management server 200 transmits the received messages to the first user terminal 100. As described above, the user UA who is a requester for assistance and the user UB and user UC who are supporters are grouped in the service area AR, and messages are exchanged and shared among the user UA, user UB, and user UC. In Embodiment 1, a service activity such as providing a message regarding route guidance is described.

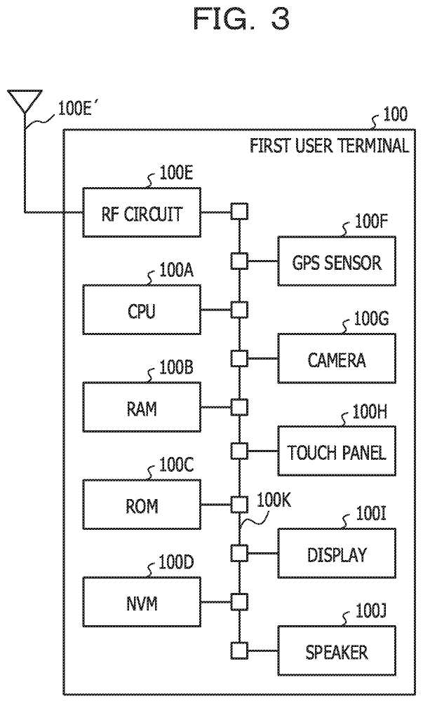

Hereinafter, details of the service activity support system ST1 will be described. FIG. 3 illustrates an example of a hardware configuration of the first user terminal 100. The second user terminals 150 and 160 have the same hardware configuration as the first user terminal 100, and thus the description thereof will be omitted. As illustrated in FIG. 3, the first user terminal 100 includes a central processing unit (CPU) 100A as a hardware processor, a random access memory (RAM) 100B, a read only memory (ROM) 100C, and a non-volatile memory (NVM) 100D, and a radio frequency (RF) circuit 100E. An antenna 100E′ is connected to the RF circuit 100E. A CPU that realizes a communication function may be used instead of the RF circuit 100E.

The first user terminal 100 includes a GPS sensor 100F, a camera 100G, a touch panel 100H, a display 100I, and a speaker 100J. The CPU 100A to the speaker 100J are connected to one another by an internal bus 100K. A micro processing unit (MPU) may be used as a hardware processor instead of the CPU 100A.

A program stored in the ROM 100C and the NVM 100D is temporarily stored in the RAM 100B by the CPU 100A. As the stored program is executed by the CPU 100A, the CPU 100A realizes various functions to be described later and executes various processes to be described later. The program may be one according to a flowchart to be described later.

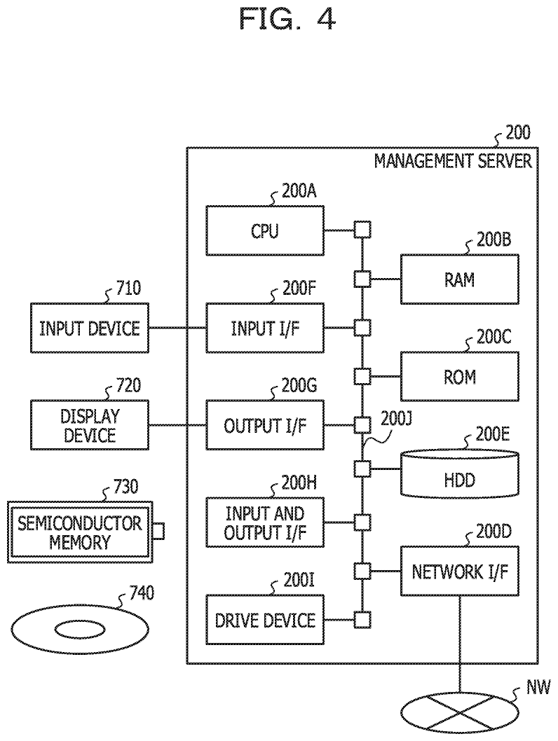

FIG. 4 illustrates an example of a hardware configuration of the management server 200. As illustrated in FIG. 4, the management server 200 includes a CPU 200A as a hardware processor, a RAM 200B, a ROM 200C or a network interface (I/F) 200D or any combination thereof. The MPU may be used as a hardware processor instead of the CPU 200A. The management server 200 may include a hard disk drive (HDD) 200E, an input I/F 200F, an output I/F 200G, an input/output I/F 200H or a drive device 200I or any combination thereof. The CPU 200A to the drive device 200I are mutually connected by an internal bus 200J. For example, the management server 200 may be realized by a computer.

An input device 710 is connected to the input I/F 200F. The input device 710 is, for example, a keyboard and a mouse. A display device 720 is connected to the output I/F 200G. The display device 720 is, for example, a liquid crystal display. A semiconductor memory 730 is connected to the input/output I/F 200H. The semiconductor memory 730 is, for example, a universal serial bus (USB) memory or a flash memory. The input/output I/F 200H reads a program or data stored in the semiconductor memory 730. The input I/F 200F and the input/output I/F 200H include, for example, a USB port. The output I/F 200G includes, for example, a display port.

A portable recording medium 740 is inserted into the drive device 200I. The portable recording medium 740 is, for example, a removable disc such as a compact disc (CD)-ROM or a digital versatile disc (DVD). The drive device 200I reads a program and data recorded on a portable recording medium 740. The network I/F 200D includes, for example, a LAN port, a communication circuit, and a network I/F card. The network I/F 200D is connected to the communication network NW described above.

The program stored in the ROM 200C or the HDD 200E is temporarily stored in the RAM 200B by the CPU 200A. The program recorded on the portable recording medium 740 is temporarily stored in the RAM 200B by the CPU 200A. As the stored program is executed by the CPU 200A, the CPU 200A realizes various functions to be described later and executes various processes to be described later. The program may be one according to a flowchart to be described later.

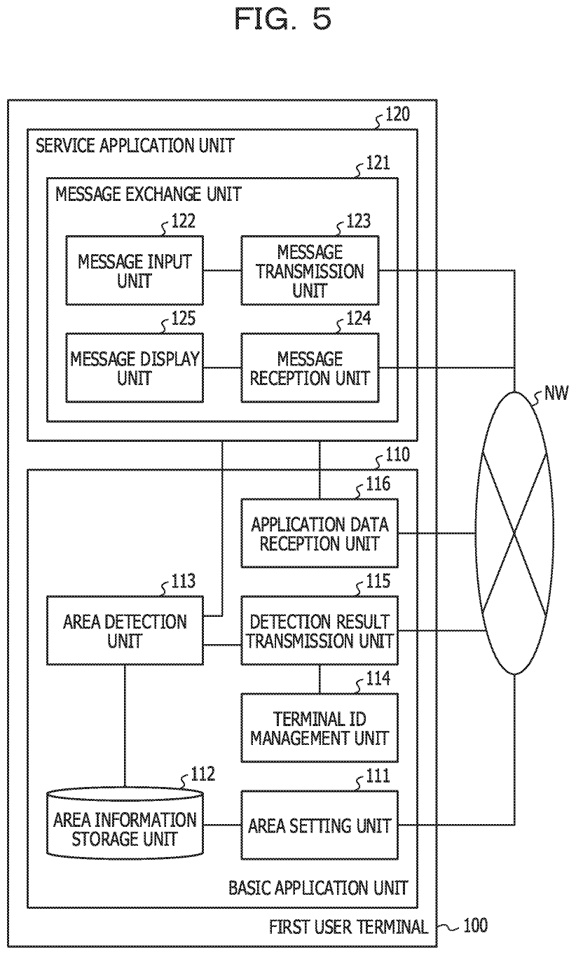

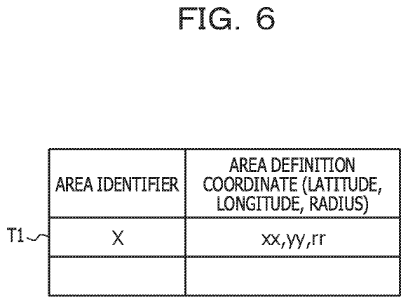

Subsequently, functions of the first user terminal 100 according to Embodiment 1 will be described. FIG. 5 illustrates an example of a block diagram of the first user terminal 100 according to Embodiment 1. FIG. 6 illustrates an example of a local area management table T1 according to Embodiment 1. The second user terminals 150 and 160 have the same functional configuration as the first user terminal 100, and thus the description thereof will be omitted. As illustrated in FIG. 5, the first user terminal 100 includes a basic application unit 110 and a service application unit 120.

The basic application unit 110 is realized by the CPU 100A executing a basic application in cooperation with the RAM 100B or the NVM 100D. The basic application is an application that controls an individual application (hereinafter, referred to as a service application) that realize a cloud service to a usable state. On the other hand, the service application unit 120 is realized by the CPU 100A executing the service application in cooperation with the RAM 100B or the NVM 100D. The basic application and the service application have a parent-child relationship, and when the basic application as a parent is not installed in the first user terminal 100, the CPU 100A may not execute the service application as a child. Before using the service application, the first user terminal 100 may obtain the basic application from the management server 200 or the like and complete installation on the first user terminal 100.

As illustrated in FIG. 5, the basic application unit 110 includes an area setting unit 111, an area information storage unit 112, an area detection unit 113, a terminal ID management unit 114, a detected result transmission unit 115 as a transmission unit, and an application data reception unit 116. The area setting unit 111 acquires static area information defining a range of the service area AR from the management server 200, and stores the static area information in the area information storage unit 112. With this configuration, as illustrated in FIG. 6, the area information storage unit 112 stores an area identifier “X” for identifying the service area AR and area definition coordinates “xx, yy, rr” for identifying the range of the service area AR by latitude, longitude, and radius in association with each other. As a result, the virtual service area AR is set in the first user terminal 100 as local area information.

The area detection unit 113 detects whether the first user terminal 100 has entered or exited the service area AR. For example, when position information of the first user terminal 100 detected by the GPS sensor 100F passes from the outside of the service area AR to the inside, the area detection unit 113 outputs in and out information including an area-in indicating an entry into the service area AR together with detection area information including the area identifier “X”. In contrast, when the position information of the first user terminal 100 detected by the GPS sensor 100F passes from the inside to the outside of the service area AR, the area detection unit 113 outputs the in and out information including an area-out indicating an exit from the service area AR together with the detection area information including the area identifier “X”. In addition to measuring of position information using such a GPS sensor 100F, position information may be measured using radio waves transmitted by beacon terminals whose installation positions have been registered in advance in the management server 200 or radio waves from a Wi-Fi (registered trademark) access point and the like, or position information may be measured by near-field communication (NFC).

The terminal ID management unit 114 manages a terminal ID (for example, a terminal ID “T-A” or the like) for identifying the first user terminal 100. The terminal ID may be associated with a name of the user UA, or part of the terminal ID may include the name of the user UA (for example, the name “Mr. A”). The name may be a real name or anonymity. IF the in and out information and the detection area information are output from the area detection unit 113, the detected result transmission unit 115 acquires the terminal ID from the terminal ID management unit 114, and transmits a detected result including the terminal ID, the in and out information, and the detection area information to the management server 200. The application data reception unit 116 receives application data transmitted from the management server 200 that has received the detected result, and outputs the received application data to the service application unit 120. Details of the application data will be described later.

When the application data output from the application data reception unit 116 is received, the service application unit 120 decompresses the received application data and develops the received application data in a message exchange unit 121 when the application data is data related to information exchange. The message exchange unit 121 includes a message input unit 122, a message transmission unit 123, a message reception unit 124, and a message display unit 125.

The message input unit 122 receives a message input by the user UA operating the touch panel 100H and outputs the message to the message transmission unit 123. The message transmission unit 123 transmits the message output from the message input unit 122 to the management server 200. The message reception unit 124 receives, for example, a message input by the user UB operating the touch panel 100H, from the management server 200 and outputs the message to the message display unit 125. The message display unit 125 displays the message output from the message reception unit 124 on the display 100I.

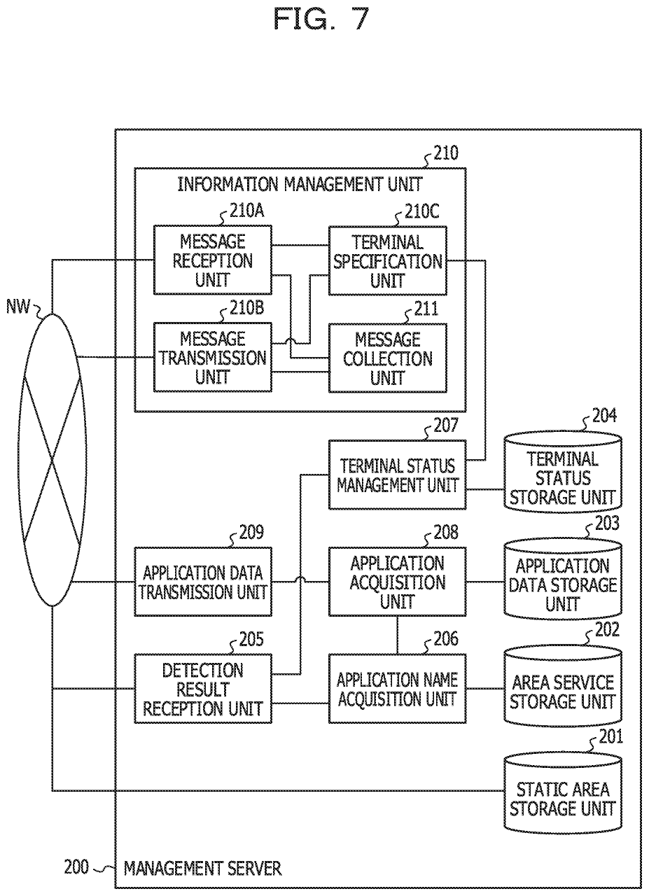

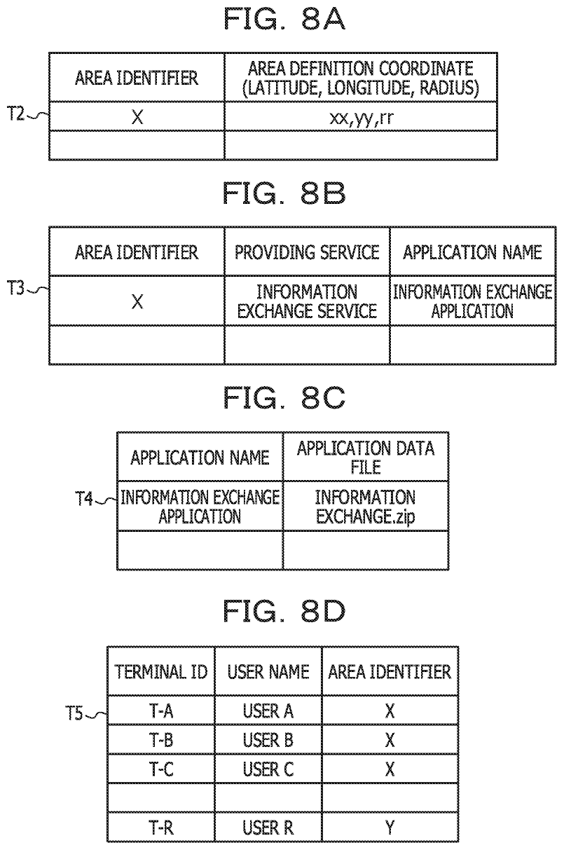

Subsequently, functions of the management server 200 according to Embodiment 1 will be described. FIG. 7 illustrates an example of a block diagram of the management server 200 according to Embodiment 1. FIG. 8A illustrates an example of a static area management table T2 according to Embodiment 1. FIG. 8B illustrates an example of an area service management table T3 according to Embodiment 1. FIG. 8C illustrates an example of an application data management table T4 according to Embodiment 1. FIG. 8D illustrates an example of a terminal state management table T5 according to Embodiment 1.

As illustrated in FIG. 7, the management server 200 includes, as components, a static area storage unit 201, an area service storage unit 202, an application data storage unit 203, and a terminal state storage unit 204. The management server 200 also includes, as components, a detected result reception unit 205, an application name acquisition unit 206, a terminal state management unit 207, an application data acquisition unit 208, an application data transmission unit 209, and an information management unit 210 as a management unit. One of the components included in the management server 200 or any combination thereof may be set in a device different from the management server 200 so that the components cooperate with each other.

The static area storage unit 201, the area service storage unit 202, the application data storage unit 203, and the terminal state storage unit 204 may be realized by the HDD 200E described above. The application name acquisition unit 206, the terminal state management unit 207, and the application data acquisition unit 208 may be realized by the CPU 200A described above. The detected result reception unit 205 and the application data transmission unit 209 may be realized by the network I/F 200D described above. Hardware elements of the information management unit 210 will be described later.

The static area storage unit 201 stores static area information. As illustrated in FIG. 8A, the static area information includes an area identifier “X” and area definition coordinates “xx, yy, rr” and is managed by the static area management table T2. Accordingly, the area setting unit 111 of the first user terminal 100 described above may acquire static area information from the static area storage unit 201.

The area service storage unit 202 stores service information including a service provided in the service area AR. As illustrated in FIG. 8B, the service information includes the area identifier “X”, provision service of the “information exchange service”, and an application name “information exchange application” of an application for realizing the provision service, and is managed by the area service management table T3. The application corresponding to the application name managed by the area service storage unit 202 is a service application. With this configuration, if the area identifier “X” for identifying the service area AR is specified, the application name associated with the specified area identifier “X” may be extracted. The area service storage unit 202 stores various service information in advance as well as the information exchange service.

The application data storage unit 203 stores application information on the service application. As illustrated in FIG. 8C, the application information includes an application name “information exchange application” and an application data file (hereinafter, referred to as application data) “information exchange.zip” obtained by compressing the application, and is managed by the application data management table T4. With this configuration, application data according to the application name may be extracted. The application data storage unit 203 stores various application data having different application names in advance. The “information exchange.zip” is, for example, application data obtained by compressing an application for realizing a chat function.

The terminal state storage unit 204 stores terminal state information. The terminal state information is information indicating the current state of the first user terminal 100 and the second user terminals 150 and 160. The current state is the service area AR to which the first user terminal 100 and the second user terminals 150 and 160 currently belong. As illustrated in FIG. 8D, the terminal state information includes a terminal ID “T-A”, a user name “Mr. A”, and an area identifier “X”, and is managed by the terminal state management table T5. In Embodiment 1, as illustrated in FIG. 8D, all the first user terminal 100 identified by the terminal ID “T-A” and the second user terminal 150 identified by a terminal ID “T-B”, the second user terminal 160 identified by a terminal ID “T-C” belongs to the service area AR identified by the area identifier “X”. For example, a user terminal (not illustrated) identified by a terminal ID “T-R” is positioned in another service area (not illustrated) identified by an area identifier “Y”. As described above, the terminal state storage unit 204 stores the terminal ID, the user name, and the area identifier in association with each other.

The detected result reception unit 205 receives the detected result transmitted from the first user terminal 100. As described above, the detected result includes the terminal ID, the in and out information, and the detection area information. The detected result reception unit 205 does not output the terminal ID included in the detected result to the application name acquisition unit 206, and outputs the in and out information and the detection area information included in the detected result to the application name acquisition unit 206. The detected result reception unit 205 outputs all the terminal ID, the in and out information, and the detection area information included in the detected result to the terminal state management unit 207.

When it is determines that the area-in is included in the in and out information output from the detected result reception unit 205, the application name acquisition unit 206 extracts an application name corresponding to the detection area information from the area service storage unit 202 based on the detection area information output from the detected result reception unit 205. Accordingly, when the application name acquisition unit 206 receives the detection area information “X”, the application name acquisition unit 206 extracts the application name “information exchange application” (see FIG. 8B). When the application name is extracted, the application name acquisition unit 206 outputs the extracted application name to the application data acquisition unit 208.

When the terminal ID, the in and out information, and the detection area information are output from the detected result reception unit 205, the terminal state management unit 207 updates terminal state information stored in the terminal state storage unit 204. For example, when area information is included in the in and out information, the terminal state management unit 207 stores the terminal state information in which the terminal ID, the user name, and the detection area information are associated with one another in the terminal state storage unit 204 (see FIG. 8D). In contrast, when the area-out is included in the in and out information, the terminal state management unit 207 deletes the terminal state information including the terminal ID, the user name, and the detection area information from the terminal state storage unit 204.

The application data acquisition unit 208 extracts application data corresponding to the application name from the application data storage unit 203, based on the application name output from the detected result reception unit 205. When the application data acquisition unit 208 extracts application data, the application data acquisition unit 208 outputs the extracted application data to the application data transmission unit 209. The application data transmission unit 209 transmits the application data output from the application data acquisition unit 208 to the first user terminal 100. With this configuration, the application data reception unit 116 of the first user terminal 100 may receive application data.

The information management unit 210 cooperates with the terminal state management unit 207, and confirms and manages terminal state information of a terminal positioned in the same service area AR through the terminal state management unit 207. The information management unit 210 includes, for example, a message integration unit 211, a message reception unit 210A, a message transmission unit 210B, and a terminal identification unit 210C as components. One of the components included in the information management unit 210 or any combination thereof may be set in a device other than the information management unit 210, and the components may be cooperated with each other. The message integration unit 211 and the terminal identification unit 210C may be realized by the CPU 200A described above. The message reception unit 210A and the message transmission unit 210B may be realized by the network I/F 200D described above.

The message reception unit 210A receives the message transmitted from the second user terminal 160. When the message reception unit 210A receives the message transmitted from the second user terminal 160, the terminal identification unit 210C cooperates with the terminal state management unit 207 based on the received message, and specifies the terminals positioned in the same service area AR through the terminal state management unit 207. When the message reception unit 210A receives the message transmitted from the second user terminal 160, the message integration unit 211 integrates the message received by the message reception unit 210A and the message transmitted from the first user terminal 100. The message integration unit 211 identifies which message the message transmitted from the second user terminal 160 is a reply to, and combines the identified message with a target message (the message transmitted from the first user terminal 100). The message transmission unit 210B transmits the integrated message obtained by integrating the two messages by the message integration unit 211 to the first user terminal 100 and the second user terminals 150 and 160 positioned in the same service area AR. With this configuration, each of the first user terminal 100 and the second user terminals 150 and 160 displays a screen including the message after being subjected to integration (see FIG. 2B).

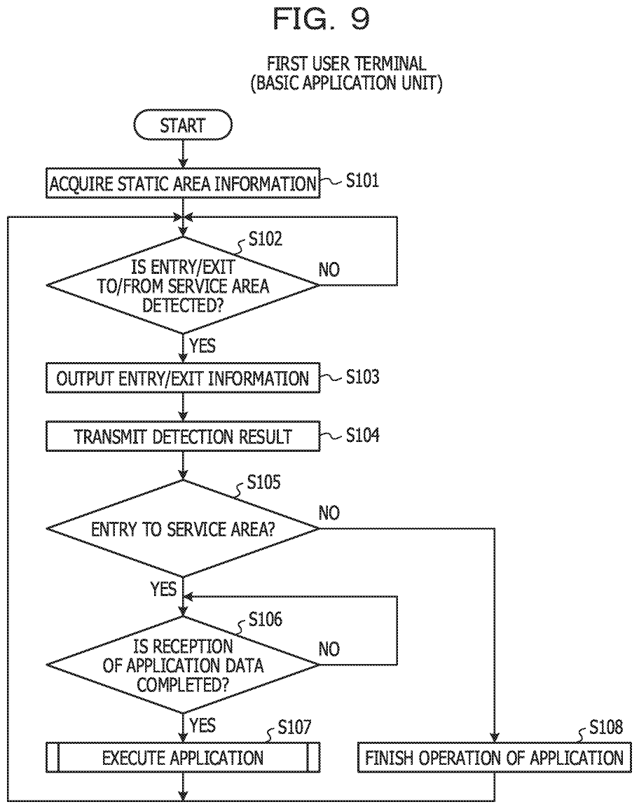

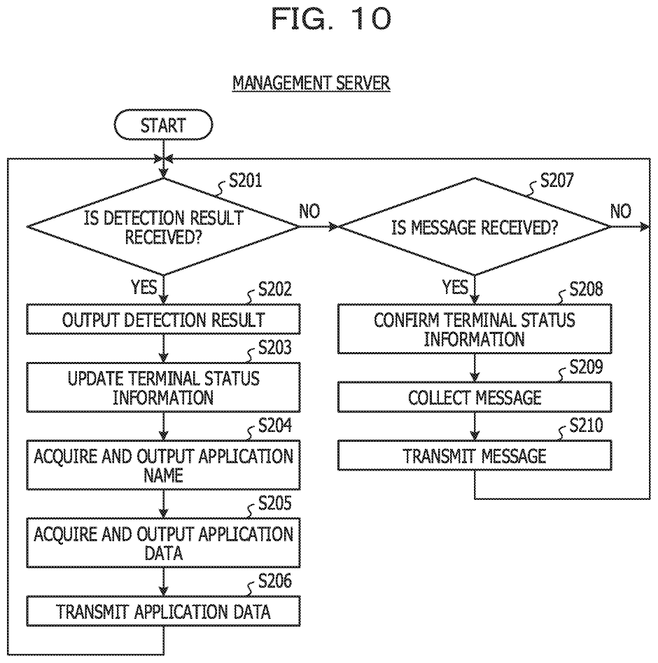

Subsequently, the operation of the service activity support system ST1 will be described with reference to FIGS. 9 and 10.

FIG. 9 illustrates a flowchart illustrating an example of the operation of the first user terminal 100 according to Embodiment 1. For example, the flowchart illustrated in FIG. 9 is executed by the basic application unit 110. As described above, the basic application for realizing the basic application unit 110 is installed in the first user terminal 100 in advance. FIG. 10 illustrates a flowchart illustrating an example of the operation of the management server 200 according to Embodiment 1. The operation of the second user terminals 150 and 160 is basically the same as the operation of the first user terminal 100 and thus, the description thereof will be omitted.

First, if the basic application is installed in the first user terminal 100, the area setting unit 111 acquires static area information as illustrated in FIG. 9 (step S101). For example, the area setting unit 111 acquires static area information by requesting the static area storage unit 201 to transmit the static area information to the first user terminal 100. When the static area information is acquired, the area setting unit 111 stores the static area information in the area information storage unit 112. With this configuration, the service area AR is set in the first user terminal 100.

When a process of step S101 is completed, the area detection unit 113 waits for a subsequent process until detecting the entry into and exit from the service area AR (NO in step S102). When the area detection unit 113 detects the entry into and exit from the service area AR (YES in step 3102), the area detection unit 113 outputs the in and out information to the detected result transmission unit 115 (step S103). For example, when the area detection unit 113 detects the entry into the service area AR, the area detection unit 113 outputs the in and out information including the area-in together with the detection area information. When the exit from the service area AR is detected, the area detection unit 113 outputs in and out information including the area-out together with the detection area information.

When the process of step S103 is completed, the detected result transmission unit 115 transmits the detected result to the management server 200 (step S104). For example, when the in and out information output from the area detection unit 113 is received, the detected result transmission unit 115 acquires the terminal ID from the terminal ID management unit 114. The detected result transmission unit 115 transmits a detected result including the acquired terminal ID, the in and out information, and the detection area information to the management server 200. When the process of step S104 is completed, the area detection unit 113 determines whether the entry into and exit from the service area AR detected in the process of step S102 is the entry into the service area AR (step S105).

As illustrated in FIG. 10, the management server 200 waits until the detected result reception unit 205 receives the detected result or the information management unit 210 receives a message (NO in step S201 or NO in step S207). When the detected result reception unit 205 receives the detected result transmitted from the first user terminal 100 (YES in step S201), the detected result reception unit 205 outputs the detected result to the application name acquisition unit 206 and the terminal state management unit 207 (step S202). For example, the detected result reception unit 205 outputs the in and out information and the detection area information included in the detected result to the application name acquisition unit 206 except for the terminal ID included in the detected result. The detected result reception unit 205 outputs all the terminal ID, the in and out information, and the detection area information included in the detected result to the terminal state management unit 207.

When the process of step S202 is completed, next, the terminal state management unit 207 updates the terminal state information (step S203). For example, when the terminal ID, the in and out information, and the detection area information output from the detected result reception unit 205 are received, the terminal state management unit 207 confirms the in and out information. When service area-in is included in the in and out information, the terminal state management unit 207 stores the terminal ID and the detection area information in the terminal state storage unit 204 in association with each other. With this configuration, the terminal state storage unit 204 stores the terminal state information (see FIG. 8D). When a service area-out is included in the in and out information, the terminal state management unit 207 deletes the terminal state information corresponding to the combination of the terminal ID and the detection area information received from the terminal state storage unit 204.

When the process of step S203 is completed, next, the application name acquisition unit 206 acquires and outputs the application name (step S204). For example, the application name acquisition unit 206 receives the in and out information and the detection area information output from the detected result reception unit 205. When the application name acquisition unit 206 determines that the received in and out information includes the area information, the application name acquisition unit 206 accesses the area service storage unit 202 and acquires an application name corresponding to the received detection area information. When the application name is acquired, the application name acquisition unit 206 outputs the acquired application name to the application data acquisition unit 208.

When the process of step S204 is completed, next, the application data acquisition unit 208 acquires and outputs application data (step S205). For example, when the application name output from the application name acquisition unit 206 is received, the application data acquisition unit 208 accesses the application data storage unit 203 and acquires application data corresponding to the received application name. In Embodiment 1, the application data acquisition unit 208 acquires the application data “information exchange.zip” (see FIG. 8C). When the application data is acquired, the application data acquisition unit 208 outputs the acquired application data to the application data transmission unit 209. When the process of step S205 is completed, next, the application data transmission unit 209 transmits the application data to the first user terminal 100 that has transmitted the detected result (step S206). When the process of step S206 is completed, the management server waits again until the detected result reception unit 205 receives a detected result or the message reception unit 210A receives a message. The process of step S203 and the processes of steps S204 to S206 may be performed in a reverse order of process or may be performed in parallel.

Returning to FIG. 9, in the first user terminal 100, when the area detection unit 113 detects the entry into the service area AR in the process of step S105 (YES in step S105), application data is dynamically transmitted from the management server 200 and thus, the application data reception unit 106 waits until the reception of application data is completed (NO in step S106). When the reception of the application data is completed (YES in step S106), the application data reception unit 106 causes the service application unit 120 to execute the application (step S107). With this configuration, the service application unit 120 executes the application. For example, when the reception of the application data is completed, the application data reception unit 106 outputs the received application data to the service application unit 120.

When the application data is received, the service application unit 120 decompresses and develops the received application data. In Embodiment 1, the service application unit 120 receives the application data “information exchange.zip” and thus, decompresses, develops, and executes the application data to thereby generate the message exchange unit 121. With this configuration, the message exchange unit of the second user terminals 150 and 160, which are similarly realized when the second user terminals 150 and 160 exist in the same service area AR as the first user terminal 100, and the message exchange unit 121 of the first user terminal 100 may exchange messages.

For example, when the first user terminal 100 enters the inside from the outside of the service area AR, the first user terminal 100 receives the application data dynamically transmitted from the management server 200 that has detected entry of the first user terminal 100 into the service area AR. Similarly, when the second user terminals 150 and 160 enter the inside from the outside of the service area AR, the second user terminals 150 and 160 receive the application data dynamically transmitted from the management server 200 that has detected the entry of the second user terminals 150 and 160 into the service area AR. Although the details will be described later, the first user terminal 100 and the second user terminals 150 and 160 existing in the same service area AR may exchange messages using the application obtained by decompressing and developing the received application data, by controlling the delivery of the message by the management server 200.

In the process of step S105, when the area detection unit 113 detects the exit from the service area AR (NO in step S105), the service application unit 120 ends the operation of the application (step S108). With this configuration, if the application is in operation, the service application unit 120 ends the operation of the application. For example, when the first user terminal 100 passes from the inside to the outside of the service area AR, exchange of messages by the message exchange unit 121 is canceled and terminated.

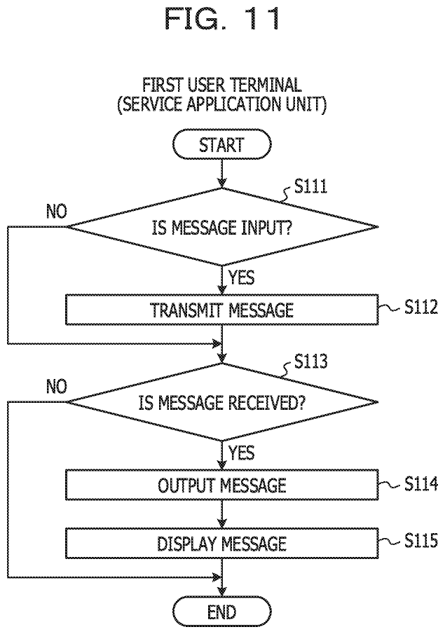

Details of step S107 described above will be described with reference to FIG. 11 together with FIG. 10. FIG. 11 illustrates a flowchart illustrating an example of the operation of the service application unit 120. As illustrated in FIG. 11, when the service application unit 120 generates the message exchange unit 121, the message input unit 122 determines whether or not a message has been input (step S111). When it is determined that the message has been input (YES in step S111), the message transmission unit 123 transmits the input message to the management server 200 (step S112). For example, the message transmission unit 123 acquires a terminal ID from the terminal ID management unit 114, and transmits the message together with the acquired terminal ID. On the other hand, when it is determined that the message is not input (NO in step S111), the message input unit 122 skips the process of step S112.

In the management server 200, as illustrated in FIG. 10, when the message reception unit 210A receives a message (YES in step 3207), the terminal identification unit 210C confirms terminal state information (step S208). For example, the terminal identification unit 210C outputs an information confirmation request to the terminal state management unit 207. The information confirmation request is information for requesting the terminal state management unit 207 to confirm the terminal state information, and includes the terminal ID transmitted from the first user terminal 100. When the information confirmation request is received, the terminal state management unit 207 acquires another terminal ID having the same area identifier as that of the terminal ID included in the information confirmation request. For example, when the terminal ID “T-A” is included in the information confirmation request, since the area identifier “X” is associated with the terminal ID “T-A” in the terminal state information (see FIG. 8D), the terminal state management unit 207 acquires the terminal ID “T-B” and the terminal ID “T-C” associated with an area identifier “X” which is the same as this area identifier “X”. When the terminal ID is acquired, the terminal state management unit 207 outputs the acquired terminal ID to the terminal identification unit 210C. With this configuration, the terminal identification unit 210C may specify the second user terminals 150 and 160 belonging to the same service area AR as the service area AR to which the first user terminal 100 belongs.

When the process of step S208 is completed, the message integration unit 211 integrates the messages (step S209). For example, the message integration unit 211 integrates the message received by the message reception unit 210A with a past message of which the service area AR, to which the user terminal belongs, is common and which continuous to the message received by the message reception unit 210A. When there is no past message, the message integration unit 211 skips the process of step S209. When the process of step 3209 is completed, the message transmission unit 210B transmits the integrated message (step S210).

For example, the management server 200 may specify the second user terminals 150 and 160 that receive a message from the first user terminal 100 and deliver the message of the first user terminal 100. Limiting user terminals to be delivered when delivering a message of a certain user terminals referred to as grouping. Since the application of the application name “information exchange application” is installed in the first user terminal 100 and the second user terminals 150 and 160, respectively, upon entry into the service area AR, the messages may be exchanged within the grouped range using the application. For example, users of the grouped user terminals may exchange messages related to service activities such as volunteers using the application of the application data delivered by the management server 200 without revealing each other's personal information (phone number, e-mail address, and the like).

For example, the message transmission unit 210B transmits the integrated message to each of the first user terminal 100 and the second user terminals 150 and 160 having the common service area AR to which the first and second user terminals 100, 150, and 160. The message reception unit 210A receives the terminal ID transmitted from the first user terminal 100. The terminal identification unit 210C receives the terminal ID acquired and output by the terminal state management unit 207. For that reason, the terminal identification unit 210C may specify the first user terminal 100 and the second user terminals 150 and 160 based on the terminal ID received by the message reception unit 210A and the terminal ID received by the terminal identification unit 210C. As a result, the message transmission unit 210B may transmit the integrated message to the first user terminal 100 and the second user terminals 150 and 160 specified by the terminal identification unit 210C. When the process of step S210 is completed, the management server waits again until the detected result reception unit 205 receives a detected result or the message reception unit 210A.

On the other hand, when the process of step S111 or S112 illustrated in FIG. 11 is completed, it is determined, in the first user terminal 100, whether or not the message reception unit 124 has received the message (step S113). This message is the integrated, but, as described above, when there is no past message, the message may be a non-integrated message. When it is determined that the message has been received (YES in step S113), the message reception unit 124 outputs the received message to the message display unit 125 (step S114). When the message output from the message reception unit 124 is received, the message display unit 125 displays the received message (step S115). With this configuration, the first user terminal 100 displays the screen including the message after integration. The second user terminals 150 and 160 also display the screen including the integrated message, similarly to the first user terminal 100. In contrast, when the message reception unit 124 receives the non-integrated message, the first user terminal 100 displays a screen including the non-integrated message. The second user terminals 150 and 160 similarly display such a screen. When it is determined that the message reception unit 124 has not received the message (NO in step S113), the processes of the subsequent steps S114 and S115 are not performed and are skipped, the process of the flowchart of FIG. 11 is ended.

Embodiment 1 has been described above with reference to FIGS. 1 to 11. According to Embodiment 1, in a case of volunteering, the volunteering may be applied to a scene where users may be connected in a certain area set on a map virtually using a geo-fence that may define the range, and messages and the like may be temporarily exchanged. As described above, in Embodiment 1, a plurality of users existing in a certain area may exchange messages related to service activities such as volunteers using the application according to the application data having the application name “information exchange application” delivered by the management server 200 without revealing each other's personal information (phone number, e-mail address, and the like).

In order to operate Embodiment 1, the following may be technically considered. Depending on the supporters, when there is a requester requesting cooperation for a certain target, there are cases where it is possible to cope with the volunteering target, and in some cases it is not possible to cope with the volunteering target. The volunteering target indicates an act to be provided or an article to be provided in a service activity such as volunteering.

For that reason, even if the requester requests volunteering, depending on an attribute of the supporter, the supporter may not be able to cooperate with the requester's request. For example, even if the requester transmits a message for requesting guidance to the supporter using the technique of Embodiment 1, if the supporter lacks in geographical knowledge and confident in the support, the supporter may want to decline the requester's request. When the supporter does not decline the requester's request, the supporter may introduce a wrong route to the requester, which may result in useless troubles between the requester and the supporter. As described above, although knowledge of geography was included as one of the attributes, the operation ability of a machine (such as a camera), an imaging technique, language ability of non-native language, physical fitness according to age and gender, and the like are also included as the attributes of the supporter. The attributes may be paraphrased as cooperative attitudes.

Even considering the described above attributes, there may be cases where the supporter is accidentally unable to respond to the requester's request. As such a situation, for example, there is a case where the supporter responds to a request of another requester. It may be bothersome to the supporter if the request for support from the requester is delivered, ignoring a situation where the supporter may not respond to the requester's request accidentally.

Even considering the attributes described above, the skill of the supporter varies, and it is difficult to maintain credibility of the supporter and quality of the volunteer. For example, even if the requester seeks a supporter with advanced imaging technique, there is no information to objectively determine the supporter's imaging technique. Therefore, if a supporter with low imaging technique erroneously responds to the request of the requester, a problem may occur between the requester and the supporter.

Even with the volunteer, the distance between the requester and the supporter may be an issue depending on the target for which the volunteering is requested. For example, in the case of photographing that requires urgent, it is desirable for the requester that the supporter exists within the predetermined distance even if the supporter exists in the same service area AR. However, it is difficult to precisely match the requester and the supporter according to the distance.

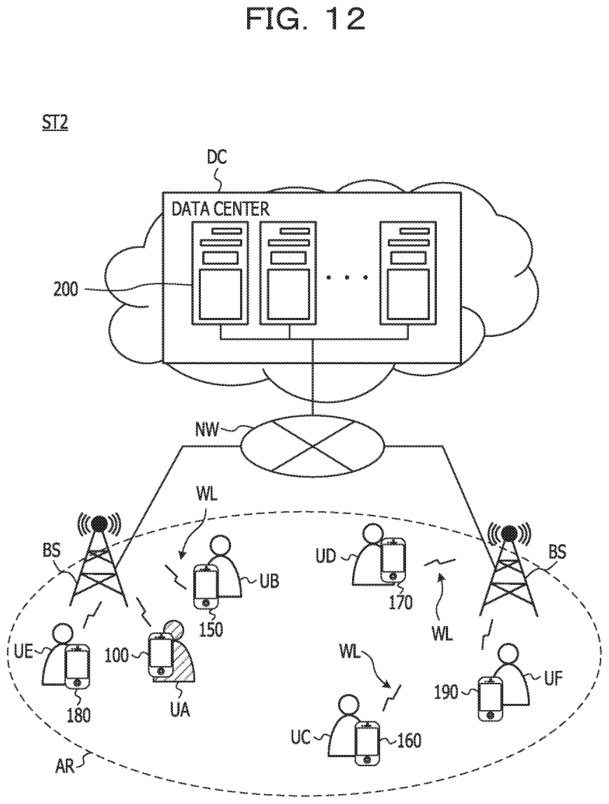

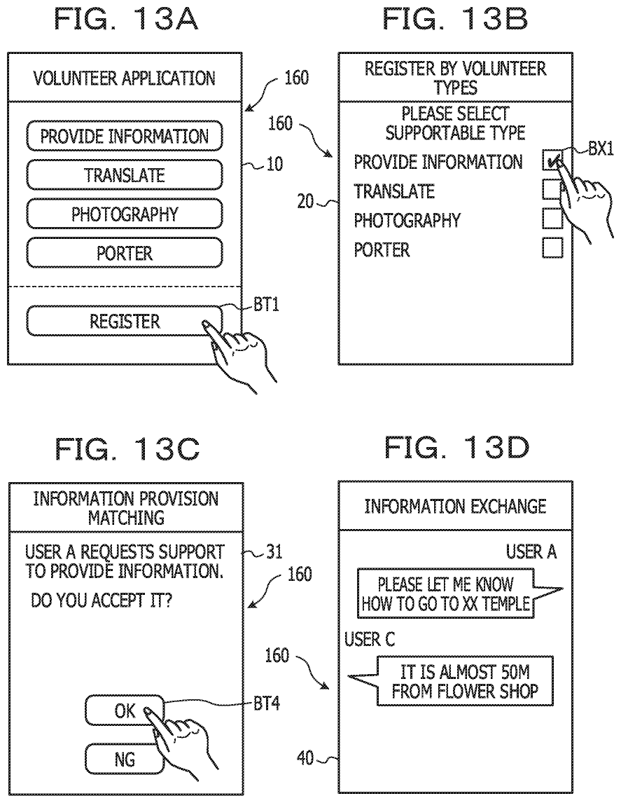

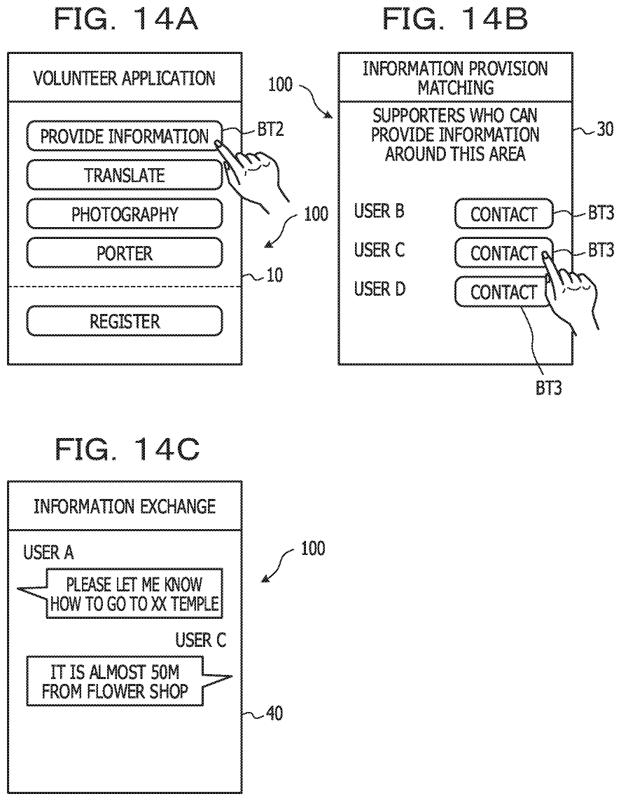

A plurality of embodiments considering the matters described above will be described with reference to drawings. FIG. 12 illustrates an example of a service activity support system ST2 according to Embodiment 2. FIGS. 13A to 13D illustrate screen display examples of the second user terminal 160 according to Embodiment 2. FIGS. 14A to 14C illustrate screen display examples of the first user terminal 100 according to Embodiment 2. The service activity support system ST2 includes the management server 200. The components of the service activity support system ST2 may include a plurality of user terminals including one first user terminal 100 and five second user terminals 150, 160, 170, 180, and 190. If the second user terminals 170, 180, and 190, and the management server 200 are included in the communicable area of a portable base station BS, similarly to the second user terminals 150 and 160, the second user terminals 170, 180, and 190 and the management server 200 are connected to each other through the wireless communication WL and the communication network NW. As described above, the second user terminals 170, 180, and 190 are also connected to the management server 200 using the wireless communication WL and the communication network NW, similarly to the first user terminal 100 and the second user terminals 150 and 160.

As illustrated in FIG. 12, the second user terminal 170 is carried by a user UD. The second user terminal 180 is carried by a user UE. The second user terminal 190 is carried by a user UF. Since the first user terminal 100 and the second user terminals 150, 160, 170, 180, and 190 are all positioned within the service area AR, a specific application (hereinafter, referred to as a volunteering application) for supporting volunteering including functions capable of transmitting and receiving messages to each other are installed in the first user terminal 100 and the second user terminals 150, 160, 170, 180, and 190. The volunteering application is an example of the service application. Under the control of the management server 200, the first user terminal 100 may transmit a volunteering request to the second user terminals 150, 160, 170, 180, and 190 in the same service area AR. All of the second user terminals 150, 160, 170, 180, and 190 may transmit information related to the support according to the request.

For example, as illustrated in FIGS. 13A and 13B, the user UC may register a type of volunteering target (hereinafter, referred to as a volunteering possible type) that the user UC may support by the second user terminal 160 in the management server 200, by the volunteering application. For example, first, the user UC performs an operation of pushing an operation button BT1 for registering the volunteering possible type on a start screen 10 of the volunteering application displayed on the second user terminal 160. When the operation is detected, the second user terminal 160 displays a volunteering type registration screen 20. For example, on the volunteering type registration screen 20 displayed on the second user terminal 160, the user UC performs an operation of pushing a check box BX1 for selecting information provision as the volunteering possible type. When the operation is detected, the second user terminal 160 registers the selected volunteering type in the management server 200 together with the terminal ID. The user UB and user UD similarly perform such an operation on the second user terminal 150 and the second user terminal 170, respectively.

On the other hand, with the volunteering application, for example, as illustrated in FIGS. 14A and 14B, the user UA may select a supporter according to the type of volunteering who wants to request the first user terminal 100. For example, first, the user UA performs an operation of pushing an operation button BT2 for selecting information provision as the type of volunteering on the start screen 10 displayed on the first user terminal 100. When the operation is detected, the first user terminal 100 displays a matching screen 30. In the matching screen 30, regarding the supporters who exist in the same service area AR as that of the user UA and have registered the information provision as the volunteering possible type in the management server 200, the names and a plurality of operation buttons BT3 for contacting the supporters are included. For example, in the matching screen 30 displayed on the first user terminal 100, the user UA performs an operation of pushing the operation button BT3 for contacting the user UC. When the operation is detected, as illustrated in FIG. 14C, the first user terminal 100 displays the information exchange screen 40. With this configuration, the user UA who is a requester may request volunteering of information provision to the user UC who is a supporter.

When the user UA performs an operation of pushing the operation button BT3, as illustrated in FIG. 13C, the second user terminal 160 displays another matching screen 31 different from the matching screen 30 based on the process of the management server 200. For example, the user UC performs an operation of pushing an operation button BT4 for accepting the request of the user UA on the matching screen 31 displayed on the second user terminal 160. When the operation is detected, the second user terminal 160 displays the information exchange screen 40 as illustrated in FIG. 13D. With this configuration, the user UC who is the supporter may provide the information according to the request of the user UA who is the requester to support the user UA.

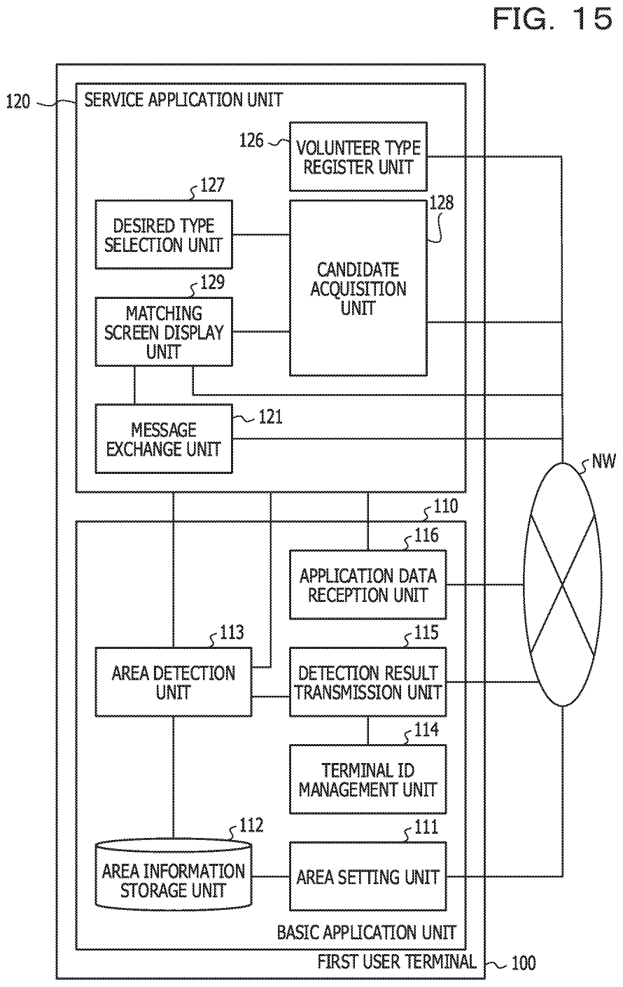

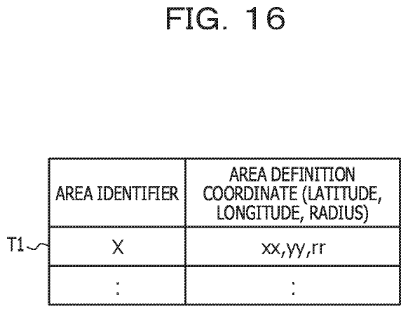

Subsequently, functions of the first user terminal 100 according to Embodiment 2 will be described. FIG. 15 illustrates an example of a block diagram of the first user terminal 100 according to Embodiment 2. FIG. 16 illustrates an example of a local area management table T11. The second user terminals 150, 160, 170, 180, and 190 have the same functional configuration as the first user terminal 100, and thus the description thereof will be omitted. The hardware configurations of the first user terminal 100 and the second user terminals 150, 160, 170, 180, and 190 are the same as the hardware configurations described with reference to FIG. 3. As illustrated in FIG. 15, the first user terminal 100 includes the basic application unit 110 and the service application unit 120.

The basic application unit 110 includes the area setting unit 111, the area information storage unit 112, the area detection unit 113, the terminal ID management unit 114, a detected result transmission unit 115, and the application data reception unit 116. The area setting unit 111 acquires static area information from the management server 200 and stores the static area information in the area information storage unit 112. With this configuration, as illustrated in FIG. 16, the area information storage unit 112 stores the area identifier “X” and the area definition coordinates “xx, yy, rr” in association with each other. As a result, a virtual service area AR is set as local area information in the first user terminal 100.

The area detection unit 113 detects whether the first user terminal 100 has entered or exited the service area AR. The terminal ID management unit 114 manages a terminal ID (for example, a terminal ID “T-A” or the like) for identifying the first user terminal 100. The terminal ID may be associated with the name of the user UA, or a part of the terminal ID may include the name of the user UA (for example, the name “Mr. A”). The detected result transmission unit 115 transmits the detected result to the management server 200. The application data reception unit 116 receives application data transmitted from the management server 200 and outputs the application data to the service application unit 120. Details of the application data according to Embodiment 2 will be described later.

When the application data output from the application data reception unit 116 is received, the service application unit 120 decompresses the received application data, and develops the received application data in the message exchange unit 121, a volunteering type registration unit 126, a desired type selection unit 127, a candidate acquisition unit 128, and a matching screen display unit 129. The message exchange unit 121 includes, as described in Embodiment 1, the message input unit 122, the message transmission unit 123, the message reception unit 124, and the message display unit 125 (all are not illustrated in FIG. 15) in FIG. 5.

The volunteering type registration unit 126 registers the volunteering possible type in the management server 200 based on the operation of the user UC who is the supporter and the like. For example, as described with reference to FIG. 13B, when an operation of registering the volunteering possible type is detected, the volunteering type registration unit 126 acquires the terminal ID managed by the terminal ID management unit 114 and transmits the acquired terminal ID and a possible type designated by a check box BX1 to the management server 200 in association with each other.

The desired type selection unit 127 transmits a desired type of the volunteering to the management server 200 based on the operation of the user UA who is the requester. For example, as described with reference to FIG. 14A, when an operation to select the desired type of volunteering is detected, the desired type selection unit 127 outputs the selected desired type to a candidate acquisition unit 128. When the desired type output from the desired type selection unit 127 is selected, the candidate acquisition unit 128 acquires the terminal ID from the terminal ID management unit 114 and transmits the acquired terminal ID and the received desired type to the management server 200. When the terminal ID and the desired type are transmitted, the candidate acquisition unit 128 acquires, from the management server 200, information of a supporter who exists in the same service area AR as the first user terminal 100 and corresponds to the desired type, as candidate information. The candidate acquisition unit 128 outputs the acquired candidate information to a matching screen display unit 129.

The matching screen display unit 129 displays the candidate information output from the candidate acquisition unit 128. For example, as described with reference to FIG. 14B, the matching screen display unit 129 displays the matching screen 30 including the candidate information. With this configuration, a volunteering requester such as the user UA may select a volunteering supporter such as the user UC. When the matching screen display unit 129 detects that specific candidate information is selected on the matching screen 30, the matching screen display unit 129 notifies the message exchange unit 121 of the selected candidate information. With this configuration, the message exchange unit 121 starts message exchange with the supporter indicated by the selected candidate information through the volunteering application.

On the other hand, when the matching screen display unit 129 receives, from the management server 200, a notification indicating that the support person has been specified, the matching screen display unit 129 displays the information on the requester. For example, as described with reference to FIG. 13C, the matching screen display unit 129 displays another matching screen 31 including information of the requester. With this configuration, the volunteering supporter such as the user UC may determine whether or not to accept the request of the volunteering requester such as the user UA. When the matching screen display unit 129 detects an operation indicating that the volunteering requester's request is accepted, the matching screen display unit 129 notifies the message exchange unit 121 to that effect. With this configuration, the message exchange unit 121 starts message exchange with the requester through the volunteering application.

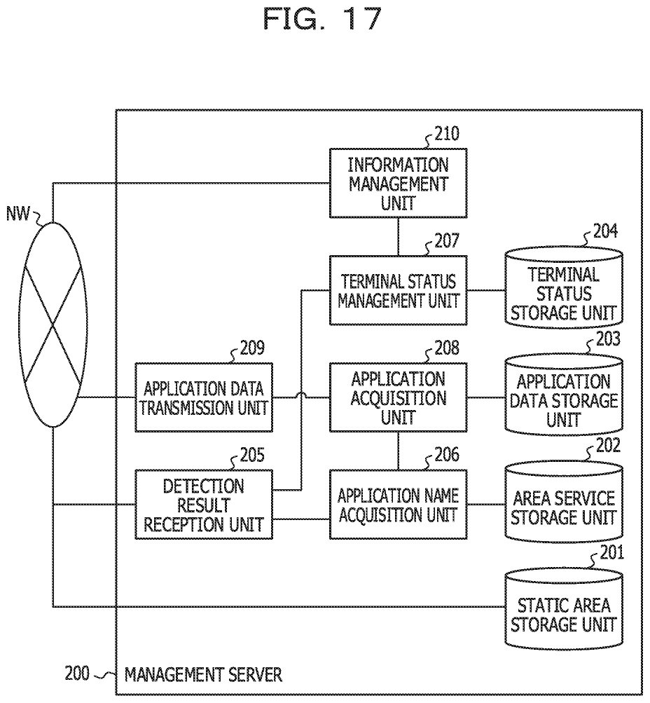

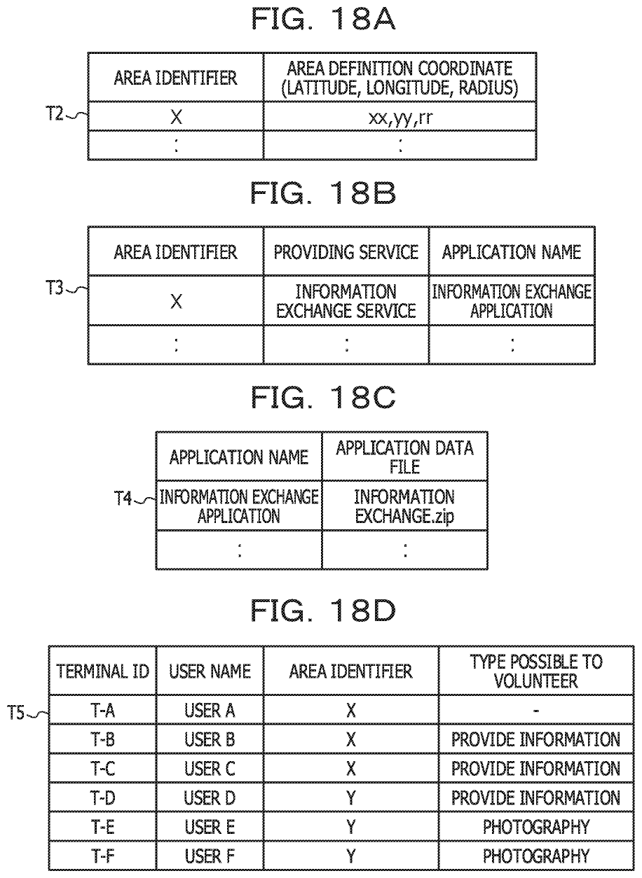

Subsequently, functions of the management server 200 according to Embodiment 2 will be described. FIG. 17 illustrates an example of a block diagram of the management server 200 according to Embodiment 2. FIG. 18A illustrates an example of a static area management table T12 according to Embodiment 2. FIG. 18B illustrates an example of an area service management table T13 according to Embodiment 2. FIG. 18C illustrates an example of an application data management table T14 according to Embodiment 2. FIG. 18D illustrates an example of a terminal state management table T15 according to Embodiment 2.

As illustrated in FIG. 17, the management server 200 according to Embodiment 2 includes, as the components, the static area storage unit 201, the area service storage unit 202, the application data storage unit 203, and the terminal state storage unit 204. The management server 200 also includes the detected result reception unit 205, the application name acquisition unit 206, the terminal state management unit 207, the application data acquisition unit 208, the application data transmission unit 209, and the information management unit 210 as a management unit. For example, the components of the management server 200 according to Embodiment 2 are the same as those of the management server 200 according to Embodiment 1. Accordingly, one of the components included in the management server 200 or any combination thereof may be set in a device different from the management server 200 so that the components cooperate with each other.

The static area storage unit 201 stores static area information. As illustrated in FIG. 18A, the static area information includes an area identifier “X” and area definition coordinates “xx, yy, rr” and is managed by the static area management table T12. Accordingly, the area setting unit 111 of the first user terminal 100 described above may acquire static area information from the static area storage unit 201.

The area service storage unit 202 stores service information including a service and the like to be provided to the service area AR. The service information includes, as illustrated in FIG. 18B, the service information includes the area identifier “X”, provision service “volunteering service”, and the application name “volunteering application” of the application for realizing the provision service, and is managed by the area service management table T13. With this configuration, when the area identifier “X” for identifying the service area AR is specified, the application name associated with the specified area identifier “X” may be extracted. The area service storage unit 202 stores various service information in advance. The volunteering application is an application that includes a chat function and supports smooth matching between the volunteering requester and the volunteering supporter.

The application data storage unit 203 stores application information related to the application. The application information includes, as illustrated in FIG. 18C, an application name “volunteering application” and application data “volunteer.zip” obtained by compressing the application, and is managed by the application data management table T14. With this configuration, application data according to the application name may be extracted. The application data storage unit 203 stores various application data having different application names in advance.

The terminal state storage unit 204 stores terminal state information. The terminal state information is information indicating the current state of the first user terminal 100, the second user terminals 150, 160, 170, 180, and 190, and the like. For example, the current state is the service area AR to which the first user terminal 100, the second user terminals 150, 160, 170, 180, and 190, and the like currently belong. As illustrated in FIG. 18D, the terminal state information includes a terminal ID “T-B” a user name “Mr. B”, an area identifier “X”, and the volunteering possible type “information provision”, and is managed by the terminal state management table T15. For example, unlike Embodiment 1, the terminal state management table T15 according to Embodiment 2 has the volunteering possible type. In Embodiment 2, as illustrated in FIG. 18D, all the first user terminal 100 identified by the terminal ID “T-A” and the second user terminal 150, . . . identified by the terminal ID “T-B”, the second user terminal 190 identified by the terminal ID “T-F” are positioned within the service area AR identified by the area identifier “X”. As described above, the terminal state storage unit 204 stores the terminal ID, the user name, the area identifier, and the volunteering possible type in association with one another.

The detected result reception unit 205 receives the detected result transmitted from the first user terminal 100. As described in Embodiment 1, the detected result includes the terminal ID, the in and out information, and the detection area information. The detected result reception unit 205 does not output the terminal ID included in the detected result to the application name acquisition unit 206, and outputs the in and out information and the detection area information included in the detected result to the application name acquisition unit 206. On the other hand, the detected result reception unit 205 outputs all the terminal ID, the in and out information, and the detection area information included in the detected result to the terminal state management unit 207.

When it is determined that the area-in is included in the in and out information output from the detected result reception unit 205, the application name acquisition unit 206 extracts an application name corresponding to the detection area information from the area service storage unit 202 based on the detection area information output from the detected result reception unit 205. Accordingly, when the application name acquisition unit 206 receives the detection area information “X”, the application name acquisition unit 206 extracts the application name “voluntary application” (see FIG. 18B). When the application name is extracted, the application name acquisition unit 206 outputs the extracted application name to the application data acquisition unit 208.

When the terminal ID, the in and out information, and the detection area information are output from the detected result reception unit 205, the terminal state management unit 207 updates terminal state information stored in the terminal state storage unit 204. For example, when area information is included in the in and out information, the terminal state management unit 207 stores the terminal ID associated with the user name and the detection area information in the terminal state storage unit 204 as the terminal state information. When the area-out is included in the in and out information, the terminal state management unit 207 deletes the terminal state information including the terminal ID and the detection area information from the terminal state storage unit 204.

When the volunteering possible type is transmitted from the second user terminal 160 together with the terminal ID, the terminal state management unit 207 receives the volunteering possible type and the terminal ID, and registers the volunteering possible type and the terminal ID in the terminal state storage unit 204. For example, the terminal state management unit 207 registers the received possibility type, the terminal ID of the terminal state information which is the same as the received terminal ID in association with each other. With this configuration, the terminal state storage unit 204 stores terminal state information in which the terminal ID, the user name, the area identifier, and the volunteering possible type are associated with one another (see FIG. 18D).

On the other hand, for example, when the terminal ID and the desired type are transmitted as a support request for volunteering from the first user terminal 100, the terminal state management unit 207 receives the terminal ID and the desired type. Thereafter, the terminal state management unit 207 accesses the terminal state storage unit 204 to specify an area identifier associated with the received terminal ID. The terminal state management unit 207 specifies the volunteering possible type of which area identifier is the same as the specified area identifier and which matches the desired type of volunteer, and transmits the user name associated with the specified volunteering possible type to the first user terminal 100. Accordingly, for example, when the terminal state management unit 207 receives a combination of the terminal ID “T-A” and the desired type “information provision”, the terminal state management unit 207 specifies the area identifier “X” associated with the terminal ID “T-A” and transmits the user names “Mr. B”, “Mr. C”, and “Mr. D”, who are associated with the possible type “information provision” of which the identified area identifier “X” is the same as the specified area identifier “X” and which matches the desired type “information provision”, to the first user terminal 100 as information of the supporters. With this configuration, the first user terminal 100 may display the matching screen 30 including information of the supporters. When the terminal state management unit 207 receives candidate information of a candidate selected on the matching screen in the first user terminal 100, the terminal state management unit 207 transmits information on the support request to the received candidate information.

The application data acquisition unit 208 extracts application data corresponding to the application name from the application data storage unit 203 based on the application name output from the detected result reception unit 205. When the application data is extracted, the application data acquisition unit 208 outputs the extracted application data to the application data transmission unit 209. The application data transmission unit 209 transmits the application data output from the application data acquisition unit 208 to the first user terminal 100. With this configuration, the application data reception unit 116 of the first user terminal 100 may receive the application data. Also for the second user terminals 150, 160, 170, 180, and 190, application data corresponding to the entered service area AR is received from the management server 200, upon entry into the service area AR.

The information management unit 210 cooperates with the terminal state management unit 207, and confirms and manages terminal state information positioned in the same service area AR through the terminal state management unit 207. As described in Embodiment 1, the information management unit 210 includes the message integration unit 211, the message reception unit 210A, the message transmission unit 210B, and the terminal identification unit 210C (all are not illustrated in FIG. 17) in FIG. 7. Accordingly, when the message reception unit 210A receives the message transmitted from the second user terminal 160, the terminal identification unit 210C cooperates with the terminal state management unit 207 based on the received message, and specifies a terminal positioned in the same service area AR through the terminal state management unit 207. When the message reception unit 210A receives the message transmitted from the second user terminal 160, the message integration unit 211 integrates the message received by the message reception unit 210A and the message transmitted from the first user terminal 100. The message transmission unit 210B transmits the integrated message obtained by integrating the two messages to the first user terminal 100 and the second user terminal 160. With this configuration, each of the first user terminal 100 and the second user terminal 160 may display a screen including the integrated message. Thus, the user UA and user UC may exchange messages.

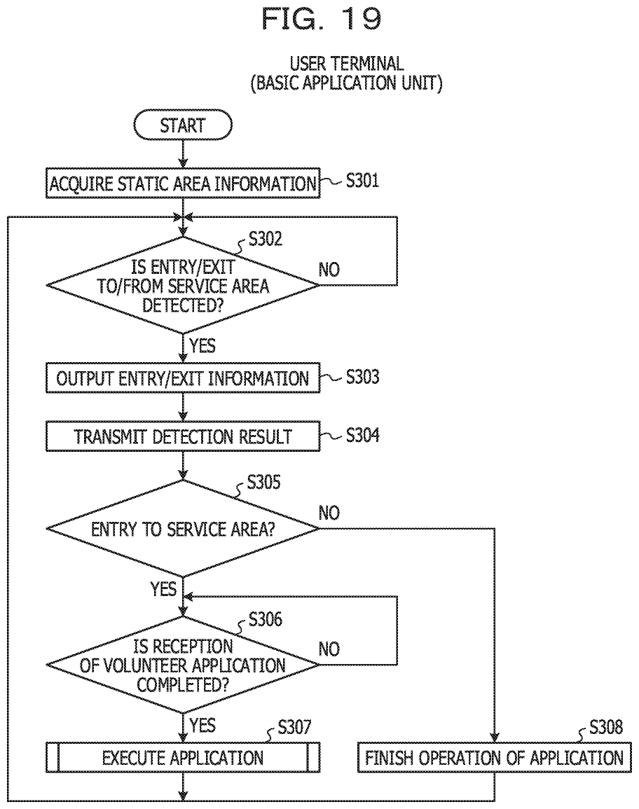

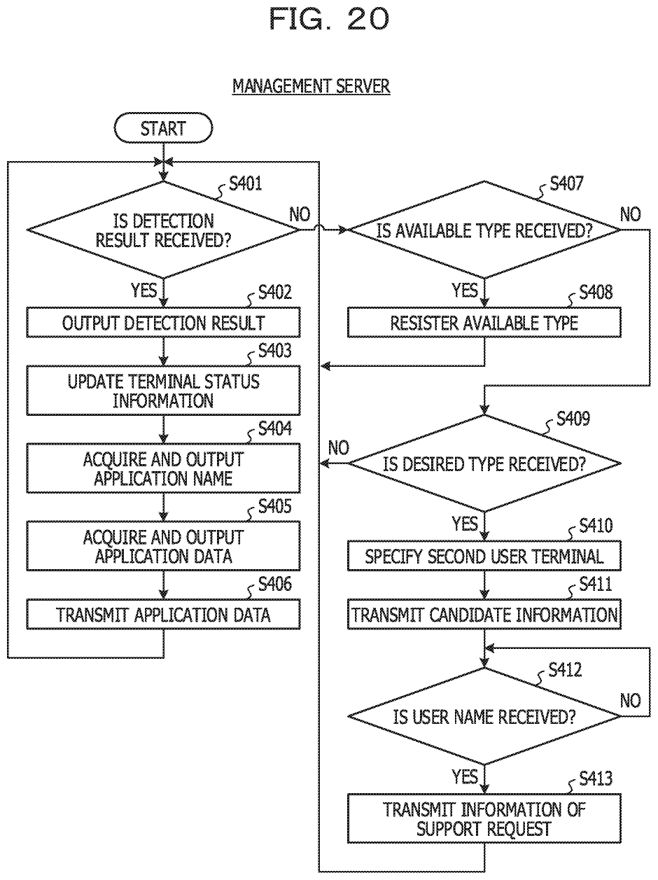

FIG. 19 is a flowchart illustrating an example of the operation of the first user terminal 100 according to Embodiment 2. For example, the flowchart illustrated in FIG. 19 is executed by the basic application unit 110. As described above, the basic application for realizing the basic application unit 110 is installed in the first user terminal 100 in advance. FIG. 20 is a flowchart illustrating an example of the operation of the management server 200 according to Embodiment 2. The operations of the second user terminals 150, 160, 170, 180, and 190 are all the same as the operation of the first user terminal 100, and thus the description thereof is omitted.

First, if the basic application is installed in the first user terminal 100, the area setting unit 111 acquires static area information as illustrated in FIG. 19 (step S301). For example, the area setting unit 111 acquires static area information by requesting the static area storage unit 201 to transmit the static area information to the first user terminal 104. When the static area information is acquired, the area setting unit 111 stores the static area information in the area information storage unit 112. With this configuration, the service area AR is set in the first user terminal 100.

When a process of step S301 is completed, the area detection unit 113 waits for a subsequent process until detecting the entry into and exit from the service area AR (NO in step S302). When the area detection unit 113 detects the entry into and exit from the service area AR (YES in step S302), the area detection unit 113 outputs in and out information to the detected result transmission unit 115 (step S303). For example, when the area detection unit 113 detects the entry into the service area AR, the area detection unit 113 outputs the in and out information including the area-in together with the detection area information. When the exit from the service area AR is detected, the area detection unit 113 outputs the in and out information including the area-out together with the detection area information.

When the process of step S303 is completed, the detected result transmission unit 115 transmits the detected result to the management server 200 (step S304). For example, when the in and out information output from the area detection unit 113 is received, the detected result transmission unit 115 acquires the terminal ID from the terminal ID management unit 114. The detected result transmission unit 115 transmits a detected result including the acquired terminal ID, in and out information, and detection area information to the management server 200. When the process of step S304 is completed, the area detection unit 113 determines whether the entry into and exit from the service area AR detected in the process of step S302 is the entry into the service area AR (step S305).

As illustrated in FIG. 20, the management server 200 waits until the detected result reception unit 205 receives the detected result, the terminal state management unit 207 receives the volunteering possible type, or the terminal state management unit 207 receives the desired type of volunteering (NO in step S401, NO in step S407, or NO in step S409). When the detected result reception unit 205 receives the detected result transmitted from the first user terminal 100 (YES in step S401), the detected result reception unit 205 outputs the detected result to the application name acquisition unit 206 and the terminal state management unit 207 (step S402). For example, the detected result reception unit 205 outputs the in and out information and the detection area information included in the detected result to the application name acquisition unit 206. The detected result reception unit 205 outputs all the terminal ID, the in and out information, and the detection area information included in the detected result to the terminal state management unit 207.

When the process of step S402 is completed, next, the terminal state management unit 207 updates the terminal state information (step S403). For example, when the terminal ID, the in and out information, and the detection area information output from the detected result reception unit 205 are received, the terminal state management unit 207 confirms the in and out information. When it is determined that the service area-in is included in the in and out information, the terminal state management unit 207 stores the terminal ID and the detection area information in the terminal state storage unit 204 in association with each other. With this configuration, the terminal state storage unit 204 stores the terminal state information. When the service area-out is included in the in and out information, the terminal state management unit 207 deletes the terminal state information corresponding to the combination of the terminal ID and the detection area information received from the terminal state storage unit 204.

When the process of step S403 is completed, next, the application name acquisition unit 206 acquires and outputs the application name (step S404). For example, the application name acquisition unit 206 receives the in and out information and the detection area information output from the detected result reception unit 205. When it is determined that the received in and out information includes the area information, the application name acquisition unit 206 accesses the area service storage unit 202 and acquires an application name corresponding to the received detection area information. When the application name is acquired, the application name acquisition unit 206 outputs the acquired application name to the application data acquisition unit 208.

When the process of step S404 is completed, next, the application data acquisition unit 208 acquires and outputs application data (step S405). For example, when the application name output from the application name acquisition unit 206 is received, the application data acquisition unit 208 accesses the application data storage unit 203 and acquires the application data corresponding to the received application name. In Embodiment 2, the application data acquisition unit 208 acquires the application data “volunteer.zip” (see FIG. 18C). When the application data is acquired, the application data acquisition unit 208 outputs the acquired application data to the application data transmission unit 209. When the process of step S405 is completed, next, the application data transmission unit 209 transmits the application data to the first user terminal 100 that has transmitted the detected result (step S406). When the process of step S406 is completed, the management server waits until the detected result reception unit 205 receives the detected result, the terminal state management unit 207 receives the volunteering possible type, or the terminal state management unit 207 receives the desired type of volunteer. The process of step S403 and the processes of steps S404 to S406 may be performed in a reverse order of process or may be performed in parallel.

Returning to FIG. 19, in the first user terminal 100, when the area detection unit 113 detects the entry into the service area AR in the process of step S305 (YES in step S305), the application data reception unit 106 waits until the reception of application data transmitted from the management server 200 is completed (NO in step S306). When the reception of the application data is completed (YES in step S306), the application data reception unit 106 causes the service application unit 120 to execute the application (step S307). With this configuration, the service application unit 120 executes the application. For example, when the reception of the application data is completed, the application data reception unit 106 outputs the received application data to the service application unit 120. When the application data is received, the service application unit 120 decompresses and develops the received application data. In Embodiment 2, the service application unit 120 receives the application data “volunteer.zip” and thus, decompresses, develops, and executes the application data to thereby generate the message exchange unit 121, the volunteering type registration unit 126, the desired type selection unit 127, the candidate acquisition unit 128, and the matching screen display unit 129. With this configuration, the message exchange unit 121, the volunteering type registration unit 126, the desired type selection unit 127, the candidate acquisition unit 128, and the matching screen display unit 129 may exhibit functions of these units, respectively.

Accordingly, in the case of the second user terminal 160, the volunteering possible type may be registered in the management server 200. In the case of the first user terminal 100, if a desired type of volunteering is selected, it is possible to display the matching screen 30 including information of a supporter of which the area identifier is the same as that of the first user terminal 100 and has registered the volunteering possible type according to the selected desired type.

In the process of step S305, when the area detection unit 113 detects the exit from the service area AR (NO in step S305), the service application unit 120 ends the operation of the application (step S308). With this configuration, if the application is in operation, the service application unit 120 ends the operation of the application. For example, when the first user terminal 100 passes from the inside to the outside of the service area AR, the message exchange unit 121 may not exchange messages.

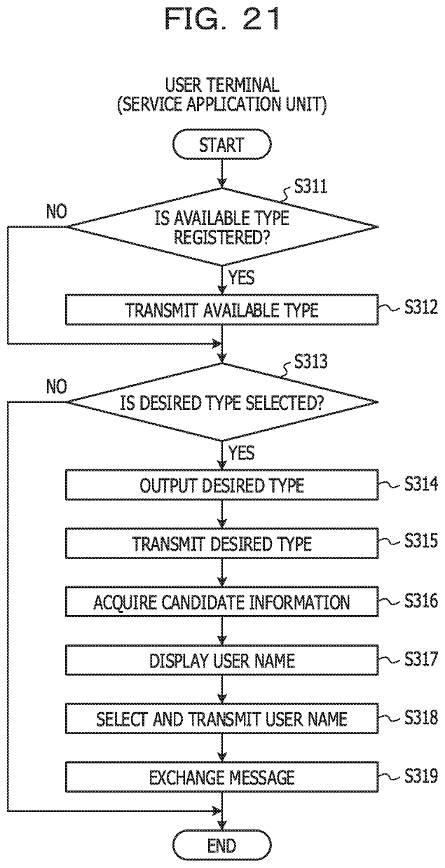

Details of step S307 described above will be described with reference to FIG. 21 together with FIG. 20. FIG. 21 is a flowchart illustrating an example of the operation of the service application unit 120 according to Embodiment 2. As illustrated in FIG. 21, when the service application unit 120 generates the message exchange unit 121, the volunteering type registration unit 126, the desired type selection unit 127, the candidate acquisition unit 128, and the matching screen display unit 129, the volunteering type registration unit 126 determines whether or not the volunteering possible type is registered (step S311). When it is determined that the volunteering possible type is registered (YES in step S311), the volunteering type registration unit 126 transmits the possible type to the management server 200 (step S312). For example, the volunteering type registration unit 126 acquires the terminal ID from the terminal ID management unit 114, and transmits the possible type together with the acquired terminal ID. On the other hand, when it is determined that the possible type is not registered (NO in step S311), the volunteering type registration unit 126 skips the process of step S312.

In the management server 200, as illustrated in FIG. 20, when the terminal state management unit 207 receives the possible type (YES in step S407), the possible type is registered (step S408). For example, when the possible type and the terminal ID is received, the terminal state management unit 207 registers a combination of the received terminal ID and the possible type in the terminal state storage unit 204 as terminal state information. For example, when the terminal state management unit 207 receives the possible type “information provision” and the terminal ID “T-C”, since the terminal ID “T-C” is registered in the terminal state information in association with the area identifier “X” and the user name “C”, the terminal state management unit 207 registers the received possible type “information provision” and the terminal state information including the received terminal ID “T-C” in association with each other (see FIG. 18D). When the process of step S408 is completed, the process of the flowchart returns to the process of step S401.

On the other hand, when the processes of step S311 or S312 illustrated in FIG. 21 are completed, it is determined whether or not the desired type selection unit 127 has selected the desired type based on the operation (step S313). When it is determined that the desired type selection unit 127 has selected the desired type (YES in step S313), the desired type selection unit 127 outputs the desired type to the candidate acquisition unit 128 (step S314). When the desired type is received, the candidate acquisition unit 128 transmits the received desired type to the management server 200 (step S315). For example, the candidate acquisition unit 128 acquires the terminal ID from the terminal ID management unit 114, and transmits the desired type together with the acquired terminal ID.

In the management server 200, as illustrated in FIG. 20, when the terminal state management unit 207 receives the desired type (YES in step S409), one of the second user terminals 150, 190 or any combination thereof is specified (step S410) and candidate information including the name of the user UB carrying the specified second user terminal 150 and the name of the user UC carrying the specified second user terminal 160 is transmitted to the first user terminal 100 (step S411). For example, the terminal state management unit 207 first specifies the area identifier of the first user terminal 100 based on the terminal ID received together with the desired type. Thereafter, when the terminal state management unit 207 detects the volunteering possible type of which the specified area identifier is common and corresponds to (for example, matches) the received request category, the terminal state management unit 207 specifies one of the second user terminals 150, . . . , 190 having a terminal ID associated with the detected volunteering possible type or any combination thereof. The terminal state management unit 207 specifies the user name associated with the volunteering possible type of which the specified area identifier is common and corresponds to (for example, matches) the received desired type, and transmits candidate information including the specified user name to the first user terminal 100. When the process of step S411 is completed, the terminal state management unit 207 waits until the user name is received (NO in step S412).

In the first user terminal 100, as illustrated in FIG. 21, the candidate acquisition unit 128 acquires the candidate information transmitted from the management server 200 (step S316). When the process of step S316 is completed, the matching screen display unit 129 displays one or more user names included in the candidate information (step S317). For example, the matching screen display unit 129 displays the matching screen 30 (see FIG. 14B) including one or more user names included in the candidate information and the operation buttons BT3 that respectively correspond to the user names. The matching screen display unit 129 selects any of the user names based on an instruction and transmits the user name to the management server 200 (step S318). For example, when the user name “Mr. C” is selected based on the instruction of the user UA, the matching screen display unit 129 transmits the selected user name “Mr. C” to the management server 200.

In the management server 200, as illustrated in FIG. 20, when the terminal state management unit 207 receives the user name (YES in step S412), information on the support request is transmitted (step S413), and the process of the flowchart returns to the process of step S401. For example, when the terminal state management unit 207 specifies three second user terminals 150, 160, and 170 in the process of step S410, first, the terminal state management unit 207 specifies the terminal ID “T-C” associated with the received user name “Mr. C” from among the three second user terminals 150, 160, and 170. The terminal state management unit 207 transmits information of the support request to the second user terminal 160 having the specified terminal ID “T-C”.

With this configuration, in the second user terminal 160, the matching screen display unit of the second user terminal 160 displays another matching screen 31 (see FIG. 13C). When the matching screen display unit of the second user terminal 160 detects an operation to accept the request, the matching screen display unit notifies the management server 200 to that effect.

When the information management unit 210 of the management server 200 is notified of the matters that the second user terminal 160 accepts the request from the second user terminal 160, the information management unit 210 of the management server 200 notifies the first user terminal 100 to that effect. With this configuration, as illustrated in FIG. 21, the message exchange unit 121 of the first user terminal 100 exchanges a message with the second user terminal 160 (step S319).

Accordingly, when the user UA gives an instruction to contact the user UC from among the names of the user UB, the user UC, and the user UD displayed on the first user terminal 100 (see FIG. 14B), the message exchange unit 121 exchanges a message with the second user terminal 160 through the management server 200. When it is determined that the desired type selection unit 127 has not selected the desired type (NO in step S313), the desired type selection unit 127 skips the processes from subsequent step S314 to step S319.

As described above, according to Embodiment 2, the management server 200 includes the terminal state management unit 207. When the terminal state management unit 207 receives the desired type “providing information” transmitted from the first user terminal 100 positioned inside the service area AR as the volunteering support request, the terminal state management unit 207 specifies, for example, the second user terminals 150, 160, and 170 positioned inside the service area AR according to the received desired type “information provision”. When only one of the second user terminals 150, 160, and 170 has not registered the volunteering possible type “information provision”, the terminal state management unit 207 specifies the one user terminal. When the terminal state management unit 207 specifies the second user terminals 150, 160, and 170, the terminal state management unit 207 transmits information on the support request to any of the specified second user terminals 150, 160, and 170. The transmission destination to which the terminal state management unit 207 transmits information is determined according to the selection of a holder of the second user terminal 150, 160, and 170 performed on the first user terminal 100.

With this configuration, it is possible to support the volunteering in the service area AR. According to Embodiment 2, the management server 200 manages the volunteering possible type registered by the user who may be a supporter. Accordingly, in Embodiment 2, even if the requester requests volunteering, it is possible to disclose a situation in which the supporter may not cooperate with the request of the requester depending on the attribute (volunteering possible type) of the supporter.

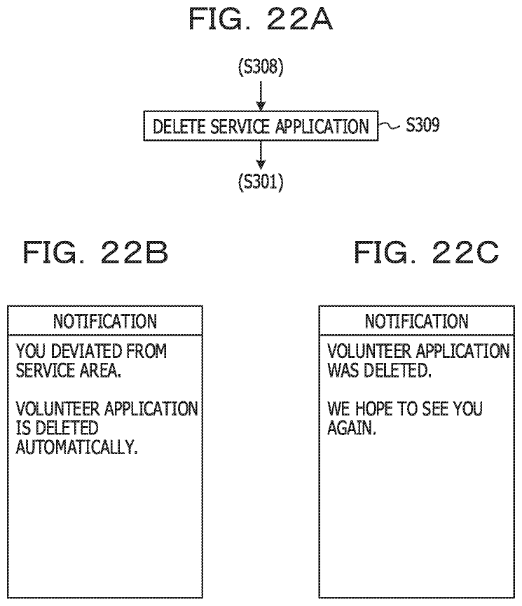

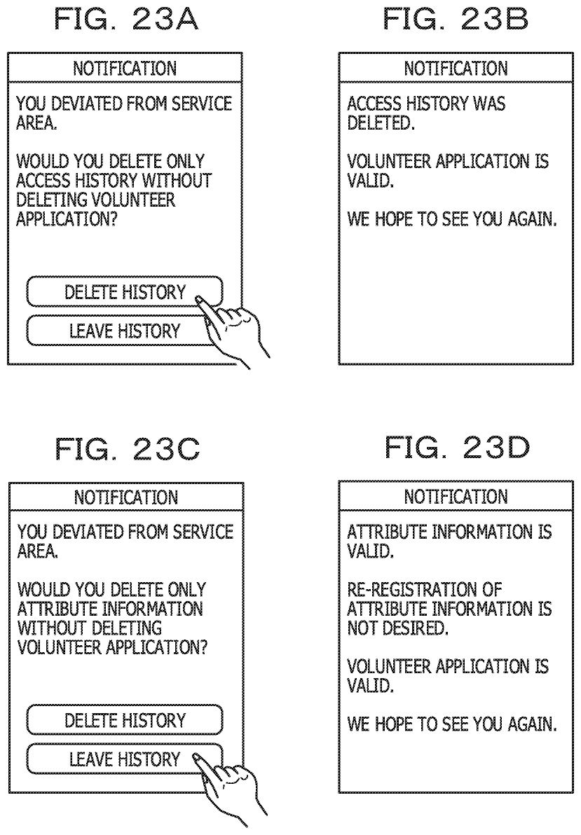

Subsequently, Embodiment 3 of the present disclosure will be described with reference to FIGS. 22 and 23. FIG. 22A is a flowchart illustrating a part of the operation of the first user terminal 100 according to Embodiment 3. For example, the flowchart illustrated in FIG. 22A is executed by the basic application unit 110. FIGS. 22B and 22C are examples of screens displayed on each of the first user terminal 100 and the second user terminals 150, 160, 170, 180, and 190 according to Embodiment 3. FIGS. 23A to 23D are other examples of screens displayed on each of the first user terminal 100 and the second user terminals 150, 160, 170, 180, and 190 according to Embodiment 3.

As illustrated in FIG. 22A, after performing the step S309 representing a process of deleting the application after the process of step S308 described in Embodiment 2, the process of the flowchart of FIG. 22A may return to the process of step S301. With this configuration, when any of the first user terminal 100 and the second user terminals 150, 160, 170, 180, and 190 passes from the inside to the outside of the service area AR, the service application (volunteering application) is deleted. With this configuration, for example, when the first user terminal 100 has exited the service area AR, a storage area occupied by the service application installed in the first user terminal 100 is dynamically released, and the storage area increases. History information including personal information of a supporter such as the user UB or the user UC is also dynamically deleted, the storage area occupied by the history information is dynamically released, and the storage area is increased. Since the risk of information leakage of the history information is avoided by deleting the history information, security is further improved. As a result, privacy of the requester and supporter exchanging messages is secured. There is a risk that personal information may remain on the service application when information for specifying an individual is exchanged in the message exchange. For example, in the case where a requester and a supporter meet directly to provide support, such as photographing, it is conceivable to exchange personal information such as the name and clothes through a message for the purpose of waiting. In Embodiment 3, the matters that the personal information remains in each other's terminal are avoided by deleting the personal information at the timing of exiting the service area AR.

For example, in the process of step S305 described with reference to FIG. 19, when the area detection unit 113 detects the exit from the service area AR, the area detection unit 113 causes the service application unit 120 to operate the service application and then, erases the service application (step S309). For example, when the first user terminal 100 exits the service area AR, the area detection unit 113 displays a notification screen for notifying of the exit from the service area AR and erasure of service application, as illustrated in FIG. 22B. When the erasure of the service application is completed, the area detection unit 113 displays a notification screen notifying that the erasure of the service application is completed, as illustrated in FIG. 22C.

As illustrated in FIG. 23A, the area detection unit 113 may erase the history information without executing erasure of the service application according to selection of an erasure target, and may perform neither the erasure of the service application nor the erasure of the history information. For example, as illustrated in FIG. 23A, when it is selected to erase the history information without executing the erasure of the service application, the area detection unit 113 erases the history information while making the service application remain, and as illustrated in FIG. 23B, a notification screen for notifying that effect is displayed.

As illustrated in FIG. 23C, the area detection unit 113 may erase attribute information without executing the erasure of the service application according to the selection of the erasure target and may perform neither the erasure of the service application nor the erasure of the attribute information. The attribute information represents the volunteering possible type registered in the management server 200. For example, as illustrated in FIG. 23C, when the selection to make the attribute information remain is performed without executing the erasure of the service application, the area detection unit 113 notifies the management server 200 of maintenance of the attribute information while making the service application remain, and displays a notification screen notifying that effect and as illustrated in FIG. 23D. In this case, the terminal state management unit 207 of the management server 200 holds the volunteering possible type without erasing the volunteering possible type. With this configuration, the supporters such as the user UB and the user UC do not have to re-register the volunteering type, and may continue to use the service.

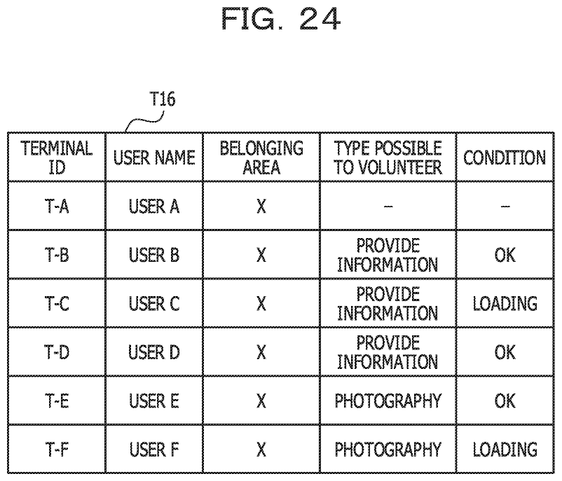

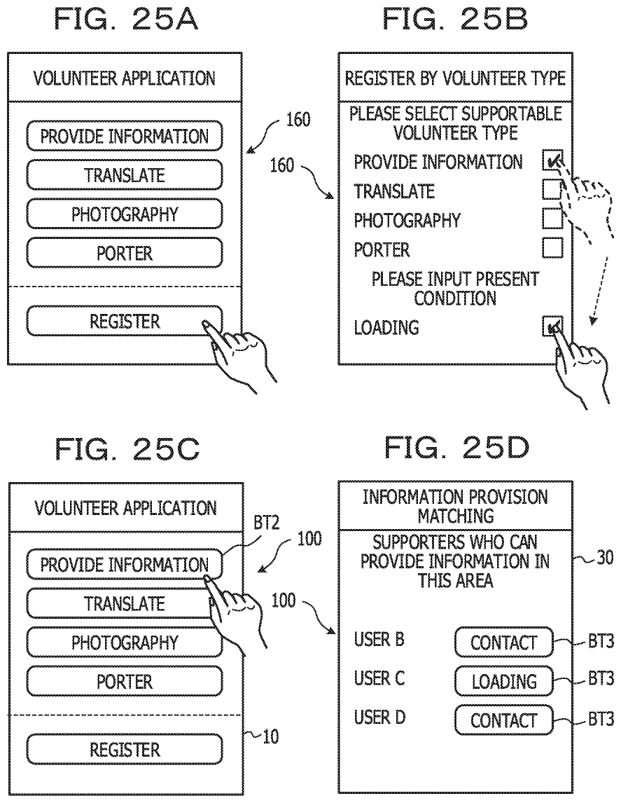

Subsequently, Embodiment 4 of the present disclosure will be described with reference to FIGS. 24 and 25. FIG. 24 illustrates an example of a terminal state management table T16 according to Embodiment 4. FIGS. 25A and 25B are screen display examples of the second user terminal 160 according to Embodiment 4. FIGS. 25C and 25D are screen display examples of the first user terminal 100 according to Embodiment 4.

In Embodiment 2, the terminal state management table T15 (see FIG. 18D) is described, but as illustrated in FIG. 24, the terminal state management table T16 in which a condition is included in the terminal state management table T15 may be adopted. The condition represents the current situation of the user UB or the user UC.

For example, as illustrated in FIGS. 25A and 25B, in Embodiment 4, the volunteering possible type “information provision” is registered from each of the second user terminals 150, 160, and 170, and the matters that the current condition is “being loaded” from the second user terminal 160 is registered. For example, when the user UC corresponds to another requester (not illustrated) different from the user UA who requests the volunteer, or when the user UC may not cope with the request at present for private use and the like, the user UC operates the second user terminal 160 to input the “being loaded” to the second user terminal 160. With this configuration, as illustrated in FIG. 24, the volunteering type registration unit 126 transmits the “being loaded” together with the terminal ID of the second user terminal 160 to the management server 200, and the terminal state management unit 207 rewrites the condition of the terminal state information including the received terminal ID from OK to “being loaded”. With this configuration, as illustrated in FIG. 24, the condition of the user UC in the terminal state management table T16 is changed to “being loaded”.

In this state, as illustrated in FIGS. 25C and 25D, for example, the user UA may select a supporter corresponding to the type of volunteering who wants the request in the first user terminal 100. For example, first, the user UA performs an operation of pushing the operation button BT2 for selecting the information provision as the type of volunteering on the start screen 10 displayed on the first user terminal 100. When the operation is detected, the first user terminal 100 displays the matching screen 30. In the matching screen 30, the names of the supporters who have registered information provision as the volunteering possible type in the management server 200 and a plurality of operation buttons BT3 for contacting the supporters supporter included by the process of the management server 200. For example, regarding the supporter who has registered the “being loaded” as a condition in the management server 200, control is performed so that a message indicating the condition is “being loaded” is displayed on the operation button BT3 and the operation of pushing the operation button BT3 is not performed. With this configuration, the user UA avoids contacting the user UC on the matching screen 30 displayed on the first user terminal 100, and performs an operation of pushing the operation button BT3 for contacting the user UB or the user UD.

As described above, according to Embodiment 4, when the supporter is accidentally put in a situation in which the supporter may not respond to the request of the requester, the requester is notified of that effect, and a useless request is not sent to the supporter who is in a situation where the supporter may not respond to the requester's request.

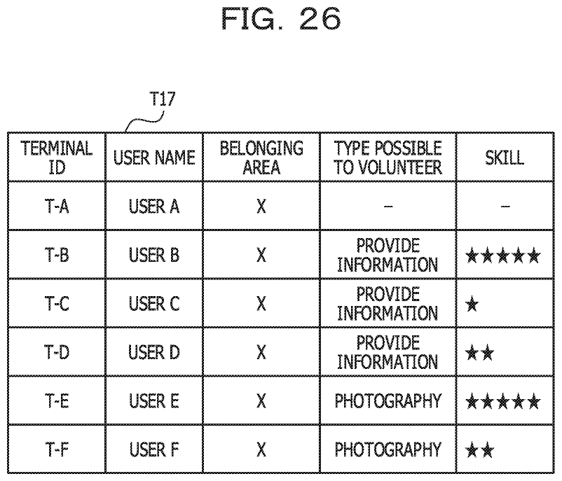

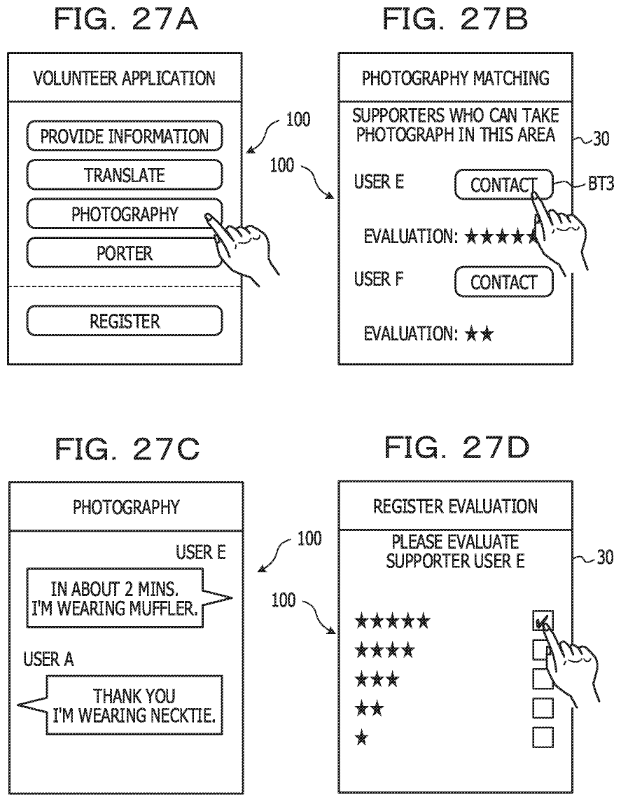

Subsequently, Embodiment 5 of the present disclosure will be described with reference to FIGS. 26 and 27. FIG. 26 illustrates an example of a terminal state management table T17 according to Embodiment 5. FIGS. 27A to 27D are screen display examples of the first user terminal 100 according to Embodiment 5.

In Embodiment 2, the terminal state management table T15 (see FIG. 18D) is described, but as illustrated in FIG. 26, the terminal state management table T17 in which a field of skill is included in the terminal state management table T15 may be adopted. The skill represents a skill level possessed by the supporter such as the user UB and the user UC. In the skill, the greater the number of stars, the higher the evaluation. In the case of information provision, for example, the skill corresponds to quality or an amount of knowledge of the geography of the supporter, and in the case of photographing, for example, the skill corresponds to quality of the imaging technique of the supporter. Similarly, in the case of interpretation, the skill corresponds to quality of language ability of a non-native language or the like, and in the case of holding luggage, the skill corresponds to quality of handling of the luggage during transportation or the like.

For example, as illustrated in FIG. 27A, when the desired type “photographing” is selected in the first user terminal 100 and transmitted to the management server 200, the management server 200 (for example, the terminal state management unit 207) specifies the user UE and the user UF for whom the volunteering type “photographing”, of which area identifier is the same as the area identifier “X” of the service area AR to which the first user terminal 100 belongs and that matches the desired type “photographing”, is registered, as candidate information. For example, the management server 200 specifies candidate information and also specifies the skill of the specified candidate information. When the candidate information and the skill are specified, the management server 200 transmits the specified candidate information and skill to the first user terminal 100. With this configuration, as illustrated in FIG. 27B, the first user terminal 100 displays the matching screen 30 including the user UE and the user UF as the specified candidate information and the skills of the candidate information.

For example, as illustrated in FIG. 27B, when the user UA instructs to push the operation button BT3 for making a contact with the user UE whose evaluation is higher than that of the user UF, the first user terminal 100 selects candidate information according to the instruction, and transmits the selected candidate information to the management server 200. When the management server 200 receives the candidate information, the management server 200 transmits information on the support request to the second user terminal 180 held by the supporter corresponding to the candidate information based on the received candidate information. With this configuration, since the second user terminal 180 displays another matching screen, the user UE may determine whether or not to accept the request of the user UA. When the user UE accepts the request of the user UA, the second user terminal 180 transmits information indicating that the request has been accepted to the management server 200. With this configuration, as illustrated in FIG. 27C, the user UA and the user UE may exchange messages regarding volunteering of photographing.

When the user UE ends the support for the user UA, the first user terminal 100 displays an evaluation registration screen as illustrated in FIG. 27D. When the user UA registers an evaluation for the user UE, the desired type selection unit 127 transmits the evaluation to the management server 200 together with the information (for example, the name and the like) of the user UE. When the information and the evaluation of the user UE is received, the terminal state management unit 207 accesses the terminal state storage unit 204 and updates the skill of the terminal state information including the received information based on the received evaluation.

As described above, according to Embodiment 5, when the requester requests a supporter having advanced imaging technique, the supporter may be selected based on the evaluation of the supporter, and trouble does not occur between the requester and the supporter.

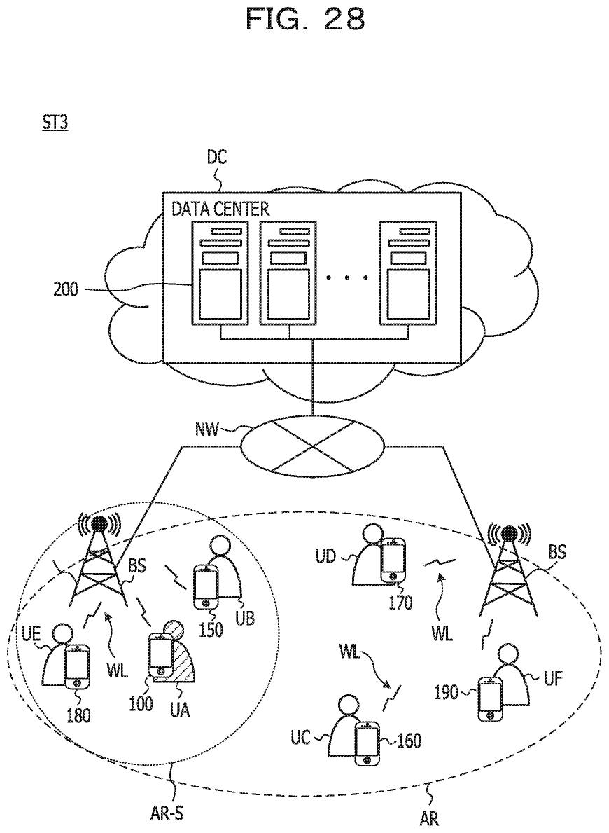

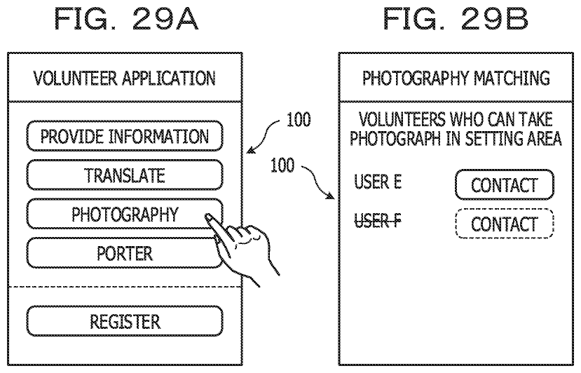

Subsequently, Embodiment 6 of the present disclosure will be described with reference to FIGS. 28 to 35. First, an outline of Embodiment 6 will be described with reference to FIG. 28. FIG. 28 illustrates an example of a service activity support system ST3 according to Embodiment 6. FIGS. 29A and 29B are screen display examples of the first user terminal 100 according to Embodiment 6. Similar to the service activity support system ST2 of Embodiment 2, the service activity support system ST3 includes a plurality of user terminals including one first user terminal 100 and five second user terminals 150, 160, 170, 180, and 190, and a management server 200 as a processing device. On the other hand, in Embodiment 6, unlike Embodiment 2, a sub-area AR-S smaller than the service area AR is set based on the position of the first user terminal 100, together with the service area AR. A range of the sub-area AR-S is determined according to the desired type of volunteering requested by the user UA, centering on the user UA. Although not illustrated in FIG. 28, the sub-area AR-S centering on the user UA is similarly set in the second user terminals 150, 160, 170, 180 and 190.

Although the details will be described later, from among the supporters who belong to the service area AR and also belong to the sub-area AR-S, the management server 200 specifies the supporter who has registered the volunteering possible type according to the desired type as candidate information. For example, even if both the user UE and the user UF have registered photographing as the volunteering possible type, if the user UF does not belong to the sub-area AR-S as illustrated in FIG. 28, the user UF may not be specified as candidate information as illustrated in FIGS. 29A and 29B. Accordingly, in this case, the user UE belonging to both the service area AR and the sub-area AR-S is specified as the candidate information. For example, the user UF positioned outside the range determined according to the desired type of volunteering requested by the user UA, centering on the user UA, is excluded from specification targets for the candidate information. The user UE positioned within a certain range determined according to the desired type of the volunteering requested by the user UA is specified as candidate information, centering on the user UA. Accordingly, the user UE may quickly respond to an urgent request of the user UA.

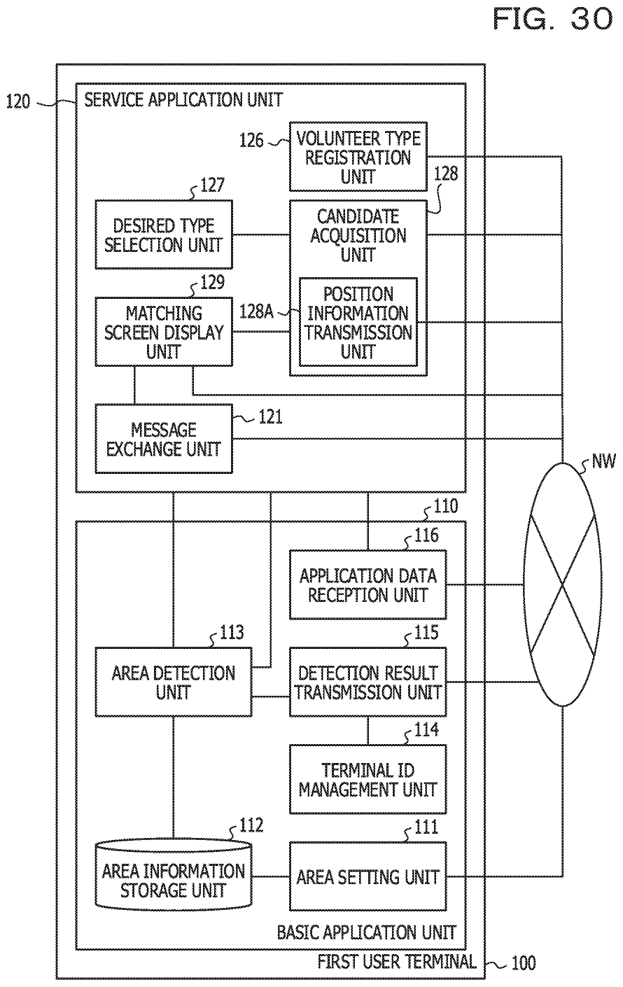

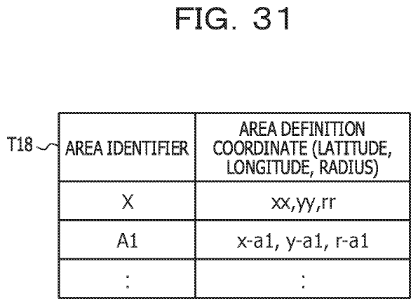

Details of Embodiment 6 will be described below. FIG. 30 illustrates an example of a block diagram of the first user terminal 100 according to Embodiment 6. FIG. 31 illustrates an example of a local area management table T18 according to Embodiment 6. The second user terminals 150, 160, 170, 180, and 190 have the same functional configuration as the first user terminal 100, and thus the description thereof will be omitted. The hardware configurations of the first user terminal 100 and the second user terminals 150, 160, 170, 180, and 190 are the same as the hardware configurations described with reference to FIG. 3. The same components as those illustrated in FIG. 15 are basically given the same reference numerals, and the description thereof will be omitted. As illustrated in FIG. 30, the first user terminal 100 according to Embodiment 6 is the same as the first user terminal 100 according to Embodiment 2 except that the candidate acquisition unit 128 includes a position information transmission unit 128A.

The area setting unit 117 according to Embodiment 6 acquires static area information from the management server 200 and stores the static area information in the area information storage unit 112. With this configuration, as illustrated in FIG. 31, the area information storage unit 112 stores the area identifier “X” and the area definition coordinates “xx, yy, rr” in association with each other. With this configuration, a virtual service area AR is set as local area information in the first user terminal 100. The area setting unit 117 acquires dynamic area information, which will be described later, from the management server 200, and stores the acquired dynamic area information in the area information storage unit 112. With this configuration, as illustrated in FIG. 31, the area information storage unit 112 stores an area identifier “A1” and area definition coordinates “x-a1, y-a1, r-a1” in association with each other. As a result, a virtual sub-area AR-S is set as local area information in the first user terminal 100.

On the other hand, when the first user terminal 100 enters the service area AR, the position information transmission unit 128A acquires the terminal ID from the terminal ID management unit 114 and newly generates an area identifier to be assigned to the sub area AR-S. The position information transmission unit 128A may use a predetermined area identifier without generating a new area identifier. When the position information transmission unit 128A newly generates an area identifier, the position information transmission unit 128A transmits the new area identifier and the position information including the current position coordinates of the first user terminal 100 specified by the latitude and the longitude together with the acquired terminal ID to the management server 200. When the candidate acquisition unit 128 receives the desired type from the desired type selection unit 127 after the position information transmission unit 128A transmits the position information and the terminal ID, the candidate acquisition unit 128 transmits the received desired type and the new area identifier to the management server 200.

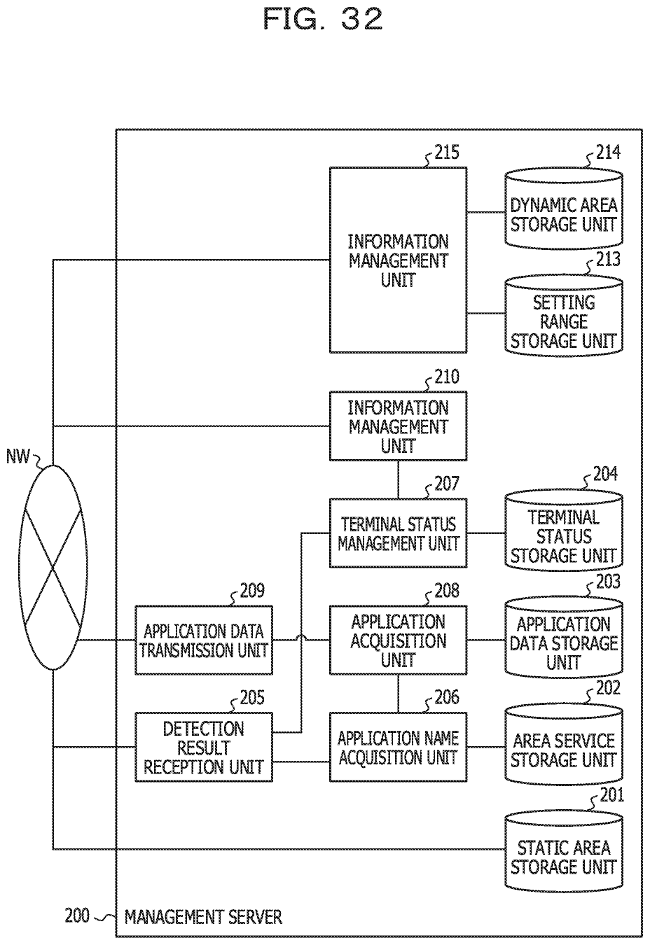

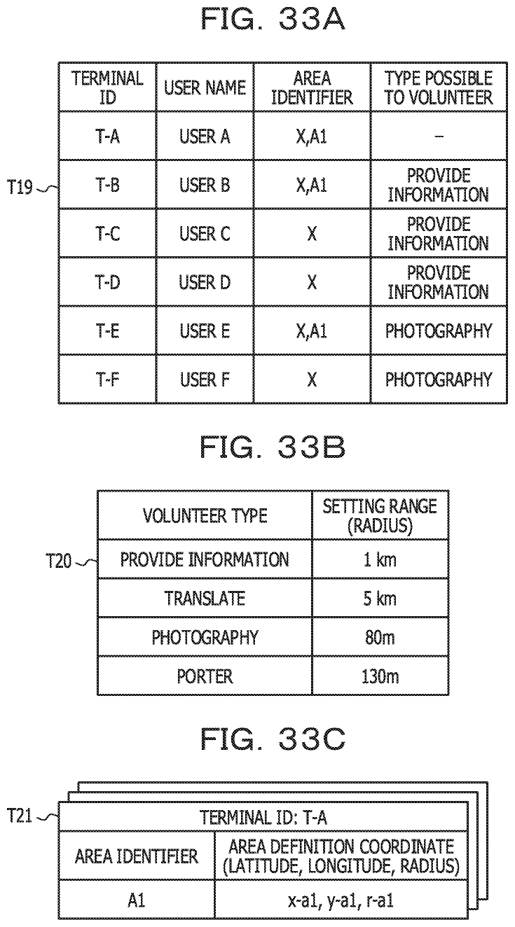

FIG. 32 illustrates an example of a block diagram of the management server 200 according to Embodiment 6. FIG. 33A illustrates an example of a terminal state management table T19 according to Embodiment 6. FIG. 33B illustrates an example of a setting range management table T20 according to Embodiment 6. FIG. 33C illustrates an example of a dynamic area management table T21 according to Embodiment 6.

The same reference numerals as illustrated in FIG. 17 basically given the same reference numerals, and the description thereof will be omitted. As illustrated in FIG. 32, the management server 200 according to Embodiment 6 is basically the same as Embodiment 2 except that the management server 200 further includes a setting range storage unit 213, a dynamic area storage unit 214, and a dynamic area setting unit 215. The setting range storage unit 213 and the dynamic area storage unit 214 may be realized by the HDD 200E described above. The dynamic area setting unit 215 may be realized by the CPU 200A described above.

The terminal state storage unit 204 according to Embodiment 6 stores terminal state information. The terminal state information is information indicating the current state of the first user terminal 100, the second user terminals 150, 160, 170, 180, 190, and the like. The current state according to Embodiment 6 is, for example, the service area AR or sub-area AR-S to which the first user terminal 100, the second user terminals 150, 160, 170, 180, and 190, and the like belong at the current point in time. The terminal state information includes, for example, a terminal ID “T-B” a user name “Mr. B”, area identifiers “X” and “A1”, and the volunteering possible type “information provision” as illustrated in FIG. 33A, and is managed by the terminal state management table T19. In Embodiment 6, as illustrated in FIG. 33A, the first user terminal 100 identified by the terminal ID “T-A”, the second user terminal 150, identified by the terminal ID “T-B”, and the second user terminals 190 identified by the terminal ID “T-F” are all positioned within the service area AR identified by the area identifier “X”. On the other hand, although the first user terminal 100 and both the second user terminals 150 and 180 are positioned in the sub-area AR-S identified by the area identifier “A1”, in the second user terminals 160, 170, and 190, the area identifier “A1” is not registered in the terminal state management table T19 and thus the second user terminals 160, 170, and 190 are positioned outside the sub-area AR-S. As described above, the terminal state storage unit 204 stores the terminal ID, the user name, the area identifier, and the volunteering type in association with each other.

The setting range storage unit 213 stores setting range information representing a radius of the sub-area AR-S as a setting range. As illustrated in FIG. 33B, the setting range information includes, for example, a volunteering type “photographing” and a setting range “80 m” corresponding to the volunteering type in association with each other. The setting range information is managed by the setting range management table T20. With this configuration, the setting range according to the volunteering type may be extracted.

The dynamic area storage unit 214 stores dynamic area information. As illustrated in FIG. 33C, the dynamic area information includes an area identifier “A1” identifying the sub-area AR-S and area definition coordinates “x-a1 y-a1, r-a1” defining the range of the sub-area AR-S. The dynamic area information is managed for each terminal ID by the dynamic area management table T21. As described above, the sub-area AR-S is defined by the dynamic area information. The area setting unit 111 of the first user terminal 100 described above acquires dynamic area information from the dynamic area storage unit 214.

The dynamic area setting unit 215 receives the terminal ID and the position information transmitted from the first user terminal 100. When the terminal ID and the position information are received, the dynamic area setting unit 215 accesses the dynamic area storage unit 214, associates the new area identifier included in the received position information with the position coordinates specified by the latitude and longitude, and registers the associated new area identifier and position coordinates in the dynamic area storage unit 214 as a part of the dynamic area information. When the desired type transmitted from the first user terminal 100 is received, the dynamic area setting unit 215 accesses the setting range storage unit 213 and acquires a setting range corresponding to the received desired type. When the setting range is acquired, the dynamic area setting unit 215 accesses the dynamic area storage unit 214 and registers the acquired setting range in association with the part of the dynamic area information stored in the dynamic area storage unit 214. With this configuration, the dynamic area information defining a range according to the desired type is completed (see FIG. 33C).

When the setting range is registered, the dynamic area setting unit 215 transmits the registered dynamic area information to all the first user terminal 100 and the second user terminals 150, . . . , 190. With this configuration, the sub-areas AR-S centering on the user UA are set in the first user terminal 100 and the second user terminals 150, . . . , 190, respectively. With this configuration, if the first user terminal 100 belongs to the sub-area AR-S, the area detection unit 113 may transmit detection area information “A1” to the management server 200. The area detection unit (not illustrated) of each of the second user terminals 150, . . . , 190 may similarly transmit the detection area information “A1” to the management server 200. As a result, the terminal state management unit 207 of the management server 200 may register the area identifier “A1” of the sub-area AR-S in the terminal state storage unit 204.

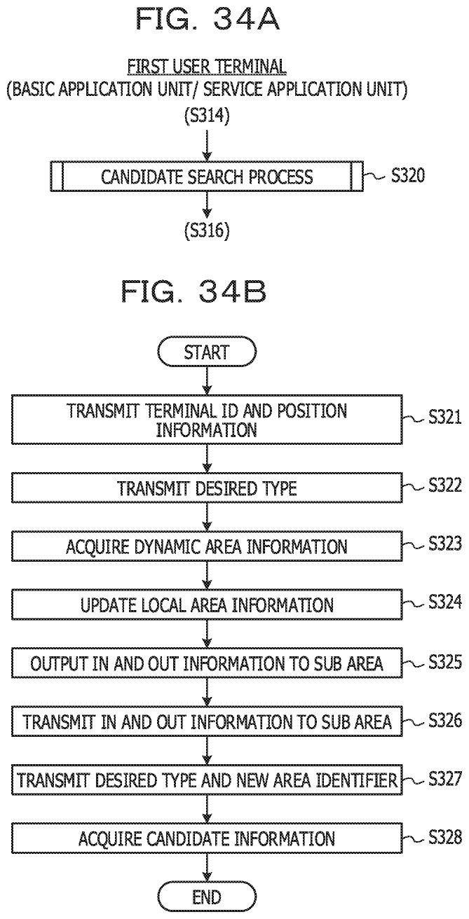

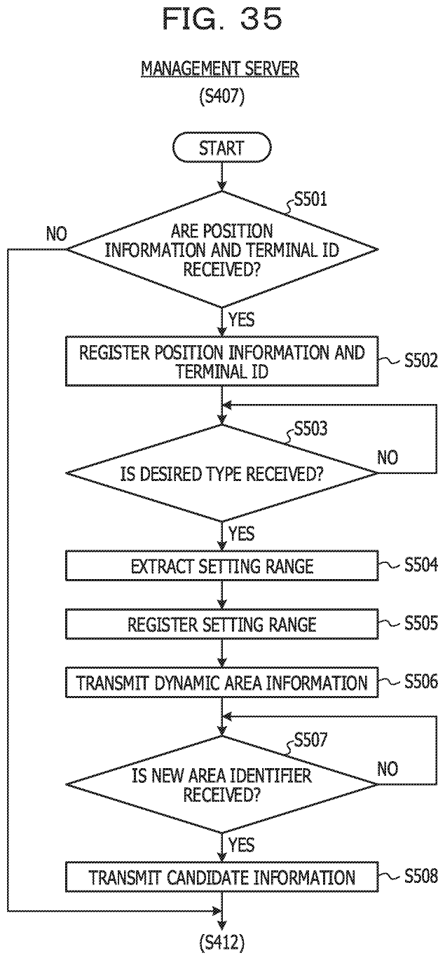

Subsequently, the operation of the service activity support system ST3 according to Embodiment 6 will be described. FIG. 34A is a flowchart illustrating a part of the operation of the first user terminal 100 according to Embodiment 6. For example, the flowchart illustrated in FIG. 34A is executed by the basic application unit 110 and the service application unit 120. FIG. 34B is a flowchart illustrating an example of a candidate search process. FIG. 35 is a flowchart illustrating a part of the operation of the management server 200 according to Embodiment 6. The operation of the basic application unit 110 is the same as the operation of Embodiment 2 described with reference to FIG. 19.

As illustrated in FIG. 34A, in Embodiment 6, the process of step S315 performed between the process of step S314 and the process of step S316 described in Embodiment 2 is changed to step S320 representing the candidate search process. With this configuration, when the desired type is transmitted from the first user terminal 100, the supporter positioned in the sub-area AR-S defined by the setting range corresponding to the desired type centering on the first user terminal 100 is displayed on the first user terminal 100 as the candidate information.

For example, in the process of step S314 described with reference to FIG. 21, when the desired type selection unit 127 outputs the desired type, the basic application unit 110 and the service application unit 120 cooperate with each other to execute the candidate search process (step S320). When the candidate search process starts, as illustrated in FIG. 34B, first, the position information transmission unit 128A transmits the terminal ID and the position information to the management server 200 (step S321). As described above, the position information includes the new area identifier and the position coordinates of the first user terminal 100. Thereafter, the candidate acquisition unit 128 transmits the desired type to the management server 200 (step S322).

As illustrated in FIG. 35, as described with reference to FIG. 20, the management server 200 waits not only until the detected result reception unit 205 receives the detected result or the terminal state management unit 207 receives the volunteering type but also until the dynamic area setting unit 215 receives the position information and the terminal ID (NO in step S401, NO in step S407, NO in step S501).

When the position information and the terminal ID transmitted from the first user terminal 100 are received (YES in step S501), the dynamic area setting unit 215 registers the position information and the terminal ID (step S502), and waits until the desired type is received (NO in step S503). For example, the dynamic area setting unit 215 associates the new area identifier and the position coordinates included in the position information with each other, registers the new area identifier and position coordinates in the dynamic area storage unit 214 as a part of the dynamic area information for each terminal ID, and waits until the desired type is received.

When the dynamic area setting unit 215 receives the desired type transmitted from the first user terminal 100 (YES in step S503), the dynamic area setting unit 215 extracts the setting range (step S504), and registers the extracted setting range in the dynamic area storage unit 214 (step S505). With this configuration, dynamic area information is completed (see FIG. 33C). For example, when the desired type is photographing, 80 meters is extracted as the setting range, and the r-a1, which is the radius of the area definition coordinates, becomes 80 meters. When the dynamic area information is completed, the dynamic area setting unit 215 transmits the dynamic area information to all the first user terminal 100 and the second user terminals 150, . . . 190 (step S506). After the dynamic area setting unit 215 transmits the dynamic area information, the terminal state management unit 207 waits until a new area identifier is received (NO in step S507).

On the other hand, as illustrated in FIG. 34B, in the first user terminal 100, when the area setting unit 111 acquires the dynamic area information transmitted from the management server 200 (step S323), the local area information is updated (step S324). With this configuration, the sub-area AR-S is set in the first user terminal 100. Similarly to the first user terminal 100, the sub-areas AR-S are also set for the second user terminals 150, . . . , 190.

As a result, for example, when the second user terminal 180 enters the sub-area AR-S, the area detection unit of the second user terminal 180 detects the entry into the second user terminal 180 into the sub-area AR-S, and outputs in and out information including area-in to the sub area AR-S together with the detection area information (step S325). In this case, the detection area information represents a new area identifier “A1”. The first user terminal 100 and the second user terminal 150 are also similar to the second user terminal 180.

When the in and out information is received, the detected result transmitting unit of the second user terminal 180 transmits the in and out information to the management server 200 (step S326). For example, when the in and out information is received together with the detection area information, the detected result transmission unit of the second user terminal 180 acquires the terminal ID from the terminal ID management unit 114. The detected result transmission unit of the second user terminal 180 transmits the acquired terminal ID, in and out information, and detection area information to the management server 200. With this configuration, in the management server 200, the terminal state management unit 207 may register the detection area information in the terminal state storage unit 204. For example, the new area identifier “A1” is registered in the terminal state management table T19 (see FIG. 33A).

When the process of step S326 is completed, next, the candidate acquisition unit 128 transmits a desired type and a new area identifier to the management server 200 (step S327). With this configuration, as illustrated in FIG. 35, in the management server 200, the terminal state management unit 207 receives the new area identifier (YES in step S507). When the terminal state management unit 207 receives the new area identifier, a corresponding supporter is extracted as candidate information, based on the new area identifier, the desired type, and the area identifier of the service area AR to which the first user terminal 100 belongs. When the candidate information is extracted, the terminal state management unit 207 transmits the extracted candidate information to the first user terminal 100 (step S508). In the first user terminal 100, as illustrated in FIG. 34B, the candidate acquisition unit 128 acquires the candidate information transmitted from the management server 200 (step S328). With this configuration, the first user terminal 100 excludes the user UF away from the user UA and displays the user UE as the candidate information (see FIG. 29B). As described above, according to Embodiment 6, the requester and the supporter may be accurately matched according to the distance between the requester and the supporter.

Although the preferred embodiments of the present disclosure have been described above in detail, the present disclosure is not limited to the specific embodiments according to the present disclosure, and various modifications may be made thereto within the scope of the subject matter of the present disclosure described in the claims. For example, neither the service area AR nor the sub-area AR-S is limited to a circle, and may be a polygon including an ellipse or a rectangle. Embodiment 2 to Embodiment 6 may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented service activity support method comprising:
in response to receiving a request for support of a first service activity transmitted from a first terminal device positioned in a specific area determined virtually in a map, identifying a second terminal device positioned in the specific area, the second terminal device being different from the first terminal device; and
transmitting information regarding the request to the identified second terminal device.

2. The service activity support method according to claim 1, wherein
the identifying is executed by positon information transmitted from the second terminal device, and
the position information is sensed by a sensor included in the second terminal device.

3. The service activity support method according to claim 1, further comprising:
storing a type of a service activity registered by each terminal device of a plurality of terminal devices, in association with each terminal device of the plurality of terminals,
wherein the identifying includes identifying the second terminal device associated with a type of a first service activity included in the request, from one or more terminal devices positioned in the specific area.

4. The service activity support method according to claim 1, further comprising:
storing a type of a service activity and a situation of a user registered by each terminal device of a plurality of terminal devices, in association with each terminal device of the plurality of terminal devices,
wherein the identifying includes identifying the second terminal device from one or more terminal devices positioned in the specific area, based on a type of a first service activity included in the request and a situation of a user of each of the one or more terminal devices.

5. The service activity support method according to claim 1, further comprising:
storing a type of a service activity and a skill level for the service activity of each of users registered by each terminal device of a plurality of terminal devices, in association with each terminal device of the plurality of terminal devices; and
transmitting, in response to the receiving of the request, information of one or more terminal devices positioned in the specific area and information of a skill level of each user of the one or more terminal devices to the first terminal device,
wherein the identifying is executed based on designation information indicating the second terminal device received from the first terminal device.

6. The service activity support method according to claim 1, further comprising:
storing a type of a service activity and range information of an area in association with each other,
wherein the identifying includes identifying the second terminal device existing in an area defined by first range information corresponding to a type of a first service activity designated by the request, from one or more terminal devices positioned in the specific area.

7. A service activity support system comprising:
a memory; and
a processor coupled to the memory and the processor configured to:
in response to receiving a request for support of a first service activity transmitted from a first terminal device positioned in a specific area determined virtually in a map, perform identification of a second terminal device positioned in the specific area, the second terminal device being different from the first terminal device, and
transmit information regarding the request o the identified second terminal device.

8. The service activity support system according to claim 7, wherein
the identification is executed by positon information transmitted from the second terminal device, and
the position information is sensed by a sensor included in the second terminal device.

9. The service activity support system according to claim 7, wherein
the processor is configure to store a type of a service activity registered by each terminal device of a plurality of terminal devices, in association with each terminal device of the plurality of terminals, and
the identification includes identifying the second terminal device associated with a type of a first service activity included in the request, from one or more terminal devices positioned in the specific area.

10. The service activity support system according to claim 7, wherein
the processor is configure to store a type of a service activity and a situation of a user registered by each terminal device of a plurality of terminal devices, in association with each terminal device of the plurality of terminal devices, and
the identification includes identifying the second terminal device from one or more terminal devices positioned in the specific area, based on a type of a first service activity included in the request and a situation of a user of each of the one or more terminal devices.

11. The service activity support system according to claim 7, wherein
the processor is configure to:
store a type of a service activity and a skill level for the service activity of each of users registered by each terminal device of a plurality of terminal devices, in association with each terminal device of the plurality of terminal devices, and
transmit, in response to the receiving of the request, information of one or more terminal devices positioned in the specific area and information of a skill level of each user of the one or more terminal devices to the first terminal device, and
the identification is executed based on designation information indicating the second terminal device received from the first terminal device.

12. The service activity support system according to claim 7, wherein
the processor is configure to store a type of a service activity and range information of an area in association with each other, and
the identification includes identifying the second terminal device existing in an area defined by first range information corresponding to a type of a first service activity designated by the request, from one or more terminal devices positioned in the specific area.

13. A non-transitory computer-readable instructions executable by one or more computers, the instructions comprising:
one or more instructions for, in response to receiving a request for support of a first service activity transmitted from a first terminal device positioned in a specific area determined virtually in a map, identifying a second terminal device positioned in the specific area, the second terminal device being different from the first terminal device; and
one or more instructions for transmitting information regarding the request to the identified second terminal device.
